(19) United States
(12) Patent Application Publication
(10) Pub. No.: US 2005/0038687 A1
(43) Pub. Date: Feb. 17, 2005

(54) Business communication solutions

(76) Inventor: Frank Anthony Galdes, Menlo Park, CA (US)

Correspondence Address: FRANK A. GALDES, 656 College Avenue, Menlo Park, CA, 94025, US

(21) Appl. No.: 10/621,965

(22) Filed: Jul. 16, 2003

Related U.S. Application Data
(60) Provisional application No. 60/396,578, filed on Jul. 16, 2002.

(51) Int. Cl. G06F 17/60

(52) U.S. Cl. 705/9; 705/1

(57) ABSTRACT

Communication solutions, particularly for enhancing business communication. The solutions being capable of receiving messages from group members and associating such message in one or more containers for provision to all group members. Group members have views of messages through a container, such as a folder, folder or.

### RELATED APPLICATION

This application claims the benefit of U.S. Provisional Application of Galdes, No. 60/396,578, filed Jul. 16, 2002, entitled STRATEGIC BUSINESS COMMUNICATION SYSTEM.

### BACKGROUND

This invention relates to communication software features, functions, applications, tools, systems, methods and other solutions, and particularly to software features, functions, applications, tools, systems, methods and other solutions in business communication.

In the not too distant past, it was commonplace for people to work in task forces, teams or other groups wherein everyone was located in one place, within one company, doing the same project comprising the same tasks, repeatedly, year in and year out. In that era, tasks tended to be relatively inflexible and, often, were rigidly defined. Communication was in person, one on one and/or in meetings wherein every group member could generally participate. As well, group management was readily able, at most any time, to assess quality, status of tasks and progress toward the whole project's completion, as well as to evaluate each group member's contributions.

However, the way people work together, in business or otherwise, changes continually. Generally, working together appears to get more complex all the time. Indeed, in the increasingly global economy, while people still work in task forces, teams or other groups, these groups seem to grow increasingly distinct from the work groups of the past. Even when people ostensibly work alone, their work typically follows the complexities of the evolving, complex work group in that such solo work tends to engender either/both (a) input from and/or output to other people, groups and entities and/or (b) a variety of reporting lines (both solid and dotted), responsibilities, authorities, hierarchies, and other connections with other persons, groups and entities.

The complexity of current work groups tends to arise along one or more parameters. For example, the members of a group may be large or small in number, diverse in skill-sets or otherwise. While group members may be located together, or at least in the same building, more typically they are located in various buildings, which buildings may be in one or more complexes, perhaps dispersed geographically across a town, city, state, country, continent, hemisphere or, often, over various locations that can be worldwide. It will be increasingly common for group members to come together on a project never having met each other and proceed to complete the project without ever meeting fact to face. It is increasingly common that some group members' physical location is not known or even needs to be known.

The group members may have the same or differing reporting paths, perhaps being in different hierarchies in a company. As well, the group members may be from different companies, which companies may be affiliated, joint venturing, or completely independent. Indeed, inter-corporate membership in a group may become increasingly common as entities seek to spread risks and stick to core competencies.

Moreover, the complexity tends to arise as members and other parameters generally are dynamic. That is the members may ebb and flow, in identity, number, skills and otherwise. At any given time in the project, one or more group member's may be known by nothing more than a name, title, telephone number, email address or the like.

As well, over time, changes may arise in the project, opportunity, effort or other work that the group is to pursue/perform. Such change may arise as component efforts, action items and other tasks become identified, defined, clarified, understood, redefined and otherwise evolve. In addition, deadlines associated with the work also may change, over time, again as component efforts, action items and other tasks become identified, clarified, understood, and evolve and/or and get re-ordered, delayed, stalled, blocked, or (in whole or in part) completed.

Adding to the complexity associated with a given project, each group member may have different responsibilities, authorities and expertise within any one project and, thus, have varying roles on a task to task basis within that project. Adding further to that complexity, each group member typically is simultaneously involved in one or more other projects. Each such other project may, but need not, have one or more group members in common with such first project. As such, there is a tendency toward time conflicts and other dislocations and disorientations as each member of a given project strives to keep productive on a given project while doing the same on an assortment of other projects.

These and other circumstances describe complex work groups. While people tend to work together in such circumstances of increasing complexity and continual change, there is a lag in the availability of software features, functions, applications, tools, systems, methods and other solutions responsive to such circumstances. Such solutions would help drive the groups to completion of their respective work, among other things, with improved quality, efficiency and productivity. Such solutions would also tend to heighten both personal and organizational accountability. As well, such solutions would help enhance the opportunity for management access, supervision and other oversight, so as to minimize or remove impediments on management assessing quality, status on tasks and progress toward the whole project's completion, as well as evaluating each group member's contributions.

In the absence of such responsive software features, functions, applications, tools, systems, methods and other solutions, complex work groups tend to fall back, by default, on what they have and know (if not being compelled to fall back in this way). These defaults include telephony, email, workflow/project management software, and data posting software.

Telephony (including audio- and video-conferencing) has some strengths, but many weaknesses. Its primary strength is to make communication between remote persons quick and personal such that the communication tends to result in shared understandings.

However, telephony simply does not otherwise provide a framework responsive to the circumstances that describe complex work groups. For example, while telephony is a standard for certain kinds of synchronous communication, it simply is not directed to asynchronous communication. As another example, telephony is very weak in providing memorialization, let alone organization, for the communications that it supports.

In contrast to telephony, email can be recognizes as the standard for asynchronous communication. Email has both a rich feature set and an intuitive interface. It is readily understood and exploited by everyone. As such, it is used widely by individuals and in organizations throughout the world. Its widespread use is coupled with permeation into many, if not essentially all, aspects of business, e.g., from organizing meetings to distributing contracts for review.

However, email also fails to respond specifically to the circumstances associated with complex work groups. For example, while email systems generally include databases wherein each email is stored, it is incumbent on each email recipient to understand the import of each email and to find valuable information embedded in the content of often multiple, generally distinct and often redundant threads associated with one task. As such, valuable information can be lost for being buried in emails.

In the following table, various attributes of email are contrasted with desirable attributes for software features, functions, applications, tools, systems, methods and other solutions that would respond more closely to the circumstances associated with complex work groups and that tend to be associated with work groups of all kinds.

| | Email | Work Groups |
|---|---|---|
| Framework | In email, the message is the | For work groups, it is desirable to |
| | framework. Metadata (e.g., a | provide a standardized framework into |
| | project deadline) is embedded | which messages can be embedded, |
| | in the message, being | wherein the framework provides for |
| | manually created by the | metadata and wherein messages are |
| | sender and deciphered by the | focused on content, toward solving the problem. |
| | reader, sometimes buried | |
| | deep in a thread. Business | |
| | process and content is, thus, | |
| | embedded in the message. | |
| Context | In email, the context generally | For work groups, it is desirable to |
| | is limited to the subject (e.g., | enhance the role of context, so that the |
| | the subject line, which may be | context tends to be clear, consistent |
| | entirely misleading vis a vis | and otherwise standardized to all |
| | the content of the message). | senders, receivers, or accessors of a |
| | Personal folders provide | message, such that, the context, |
| | some additional context, but | ultimately, is determined from the |
| | these folders generally are | outset for messages associated with |
| | not shared among the | work that the group is performing. |
| | recipients of the message, let | |
| | alone the organization. The | |
| | context, ultimately, is | |
| | determined individually (and, | |
| | potentially, differently) by | |
| | each recipient of the | |
| | message, typically only when | |
| | such recipient has finished | |
| | reading the message. As | |
| | such, context can be lost, due | |
| | to, e.g., being buried in an | |
| | email thread, redundancy | |
| | among a series of emails | |
| | (duplication and splintering of | |
| | threads), | |
| | misleading/ambiguous subject | |
| | lines, incomplete addressing | |
| | etc. | |
| Visibility | In email, a person only knows | For work groups, it is desirable to |
| | about the email if the person | enable publication of messages (e.g., |
| | is included on the thread. | to a corporate intranet) and to enable |
| | | those who have access to the intranet |
| | | site to search among or otherwise get |
| | | (some appropriate level of) access to |
| | | the messages. As such, even if a |
| | | person is not on a message thread, |
| | | that person may have sufficient access |
| | | so as to see the message and/or get |
| | | information associated with the |
| | | message, consistent with the person |
| | | completing their valid role in the |
| | | enterprise. |
| Closure | Email tends not to enable any | For work groups, it is desirable to |
| | notion of closure, e.g., | support closure, e.g., such as through |
| | respecting a project to which | explicit due dates associated with |
| | the email relates. Any due | messages. In doing so, it is desirable |
| | date generally is part of, if not | that the framework associate with a |
| | buried in, the message. | message selected flags (e.g., that |
| | | change to one or more colors indicative |
| | | of status, automatically) so that users |
| | | readily discern the priority or other |
| | | status of a message and, ultimately, so |
| | | as to facilitate management of project |
| | | closures via the system. |
| Lifecycle | Email tends not to enable any | For work groups, it is desirable that |
| | notion of lifecycle. Email | communication generally enable a |
| | tends to be open ended. | lifecycle that, preferably, is controlled |
| | | by the original author and/or owner of |
| | | the communication. As an example, |
| | | for work groups, it is desirable that |
| | | communications typically are |
| | | implemented so as to have an end of |
| | | lifecycle, i.e., to be closed. In this |
| | | example, it is also desirable that, once |
| | | a communication is closed, people are |
| | | generally precluded from adding new |
| | | content to the communication's existing |
| | | content. Further to this example, it is |
| | | also desirable that, once a |
| | | communication is closed, new content |
| | | can be added only by selected persons |
| | | (e.g., the owner and/or author) |
| | | providing an explicit re-opening. |
| Participation | In email, participation is not | For work groups, it is desirable to make |
| | tracked. In long emails, users | participation explicit, such that users |
| | must decipher who said what | agree to participate and so that |
| | and when it was said. | participation -as well as the lack of |
| | | participation -may be tracked, so as to |
| | | be substantially transparent. |
| Controlling | In email, messages are | For work groups, it is desirable to |
| Distribution | uncontrolled. A message can | subject messaging to certain controls, |
| | be forwarded (e.g., without | e.g., to make forwarding visible to the |
| | notice to or control of others) | team, to arrange messages in |
| | or otherwise splinter from a | containers, bins or other groupings, to |
| | single thread. As well, | control or preclude splintering and blind |
| | recipients can receive blind | copying and to otherwise keep |
| | copies of emails. Indeed, | messaging transparent within the |
| | people who were on the | group. |
| | original email can be dropped, | |
| | while others can be added, all | |
| | with or without notice/control. | |
| Consistency | In email, there is no standard | For work groups, it is desirable to |
| | format for business process | separate content from business |
| | or content. | process (and associated data). |
| | | Furthermore, to understand group |
| | | behavior, it is desirable to explicitly |
| | | track user gestures (e.g. forward |
| | | discussion, close discussion, etc.). |
| Public | Emails have no notion of | For work groups, it is desirable that |
| Organization | publishing results. Yet this is | messages generally be published to a |
| | the bulk of where the work is | public repository, such publication |
| | getting done. In email, | preferably being automatic. |
| | communication is opaque to | |
| | the organization.. | |
| Personal | In email, personal folders tend | For work groups, it is desirable to have |
| Organization | to be the primary, if not the | organization that is both more rigorous |
| | only, organizational tool. If a | and flexible, while also providing a |
| | user chooses to use folders, | global view which allows users to see |
| | however, the user tends to | all messages and dynamically apply |
| | impede their own global view | focusing filters. |
| | of all communication, if such | |
| | view would be available at all | |
| | to begin with. | |

Workflow/project management software generally relies on processes being defined or definable. This software also rely on processes being stable, i.e., once defined, processes retain such definition throughout the work effort and in later efforts. As such, this software tends to have utility when automating a well-understood, repeated/repeatable process (e.g., returns processing in a mail order company).

Accordingly, the utility of workflow/project management software tends to diminish when a process is not understood, is not readily definable and/or tends to change. The software tends to break down when the unexpected or unplanned happens.

Moreover, the software generally lacks flexibility and does not facilitate communication.

Like email, then, workflow/project management software does not respond specifically to the circumstances associated with complex work groups. In the following table, various attributes of this software are contrasted with desirable attributes for software features, functions, applications, tools, systems, methods and other solutions that would respond more closely to the circumstances associated with complex work groups and that tend to be associated with work groups of all kinds.

| | Workflow/Project Mgmt SW | Work Groups |
|---|---|---|
| Structure | This software typically has a rigid, | For work groups, it is desirable to |
| | complex structure, that is useful for | have a flexible, simple structure, |
| | large, static projects, while tending | so as to support optimized |
| | to be problematic for smaller, | communication for projects, |
| | dynamic projects. | regardless of size, nature or other |
| | | parameters. |
| Business | Rigorous, particularly for highly | For work groups, it is desirable to |
| Process | repeatable processes. | have process modeling that is |
| Modeling | | flexible, e.g., to handle one-off |
| | | projects that take form as they are |
| | | pursued. |
| Communication | May support communication but | For work groups, it is desirable to |
| | only in a structured well-defined | optimize for communication. |
| | environment. | |
| Flexibility | Rigid, not flexible. | For work groups, it is desirable to |
| | | provide flexibility. |

Data posting software generally is influenced by the internet/web and, particularly, the notion of virtual spaces. This software enables the posting of documents to a web site accessible to group members. While the posted documents are thus made readily available to the group members, this availability alone solves few challenges associated with the work of the complex work group. For example, availability alone tends to leave information in a pile, compelling each member to figure out the import of the document (e.g., to a task, to the project and/or to the member and their roles). Availability of information alone does little to make communication work, let alone to optimize it.

Like email and workflow/project management software, then, data posting software does not respond specifically to the circumstances associated with complex work groups. In the following table, various attributes of this software are contrasted with desirable attributes for software features, functions, applications, tools, systems, methods and other solutions that would respond more closely to the circumstances associated with complex work groups and that tend to be associated with work groups of all kinds.

| | Data Posting SW | Work Groups |
|---|---|---|
| Openness | The technology generally is | For work groups, it is desirable to |
| | “open”, but access is tightly | enable any group member to add |
| | controlled. Users typically are | additional group members (e.g., |
| | added to the system by system | using an email or similar |
| | administrators. | communication address), |
| | | preferably under the circumstances |
| | | that the addition is published to |
| | | group members. |
| Business | The technology generally | For work groups, it is desirable to |
| Process | enables little, if any, process | have process modeling that is |
| Modeling | modeling, as the focus generally | flexible, e.g., to handle one-off |
| | stays close to posting | projects that take form as they are |
| | documents. | pursued. |
| Communication | Communication usually has | For work groups, it is desirable to |
| | limitations, e.g., posting alone is | optimize communication. |
| | not optimized communication. | |
| Publication | The technology's focus | For work groups, it is desirable to |
| | generally stays close to posting | enable publication (a) the content |
| | documents. | of all communication in an easy to |
| | | use format, and organized by |
| | | project, opportunity, task or the like, |
| | | and (b) metadata, including, e.g., |
| | | deadlines and process steps and |
| | | sub-steps. |

To summarized the above, workflow/project management software and data posting software have useful attributes, but each approach falls short. Workflow/project management software focuses on the planning stage of the project. While this software is useful in performing certain work, that work generally excludes projects pursued by complex work groups (e.g., these projects lack definition up front and change over time). In turn, data posting software focuses on reviewing project information after that information is created and posted. While the information tends to be readily accessible to group members, data posting requires each group member to gauge the relevancy of any posting to their respective role and work (e.g., a form of data mining without any guidance from the software itself). Ultimately, then, these approaches both fail to respond specifically to the circumstances associated with complex work groups and the projects they pursue.

When these approaches fall short, complex work groups tend to revert to telephony and email to communicate and otherwise try to get the job done. And, as described above, while telephony and email have useful attributes, each approach again falls short. For example, in each, valuable information that group members pass to each other can easily be lost.

Inefficiencies are created by buried emails, high volumes of email traffic (e.g., spam), time-conflicted and time-consuming conference calls, and the like. Although work may be getting done, these approaches both fail to respond specifically to the circumstances associated with complex work groups and the projects they pursue.

Accordingly, needs exist for enhancements and improvements in software features, functions, applications, tools, systems, methods and other solutions that respond to the circumstances associated with work groups and their work. Moreover, needs exist for software features, functions, applications, tools, systems, methods and other solutions that respond specifically to the circumstances associated with complex work groups and their work.

### SUMMARY

This invention provides enhanced and improved software features, functions, applications, tools, systems, methods and other solutions that respond to the circumstances associated with work groups and their work. Moreover, this invention provides software features, functions, applications, tools, systems, methods and other solutions that respond specifically to the circumstances associated with complex work groups and their work. In one aspect, this invention provides communication software features, functions, applications, tools, systems, methods and solutions, and particularly software features, functions, applications, tools, systems, methods and solutions directed to business communication. Most generally, such solutions are directed, among other things, to enhance one or more of (a) efficiency, (b) productivity, (c) performance against individual, group and other organizational goals and (d) to drive forward organizational competitiveness and deliver strategic advantage.

So as to respond to circumstances associated, generally, with work groups of any type and their work and, particularly, with complex work groups and their work, software features, functions, applications, tools, systems, methods and other solutions may be variously implemented, without exhaustion, to support any one or more of the following:
Framework—a framework into which messages are embedded, wherein the framework preferably is standardized and provides for metadata, and wherein messages are focused on content, toward solving the problem;
Visibility—publication of messages (e.g., to a corporate intranet), so as to enable those who have access (e.g., to an intranet site) to search among or otherwise exploit a level of access to the messages commensurate and appropriate to their role in the enterprise, thereby enabling persons to have sufficient access to discharge their authorities and responsibilities even if they are not on a message thread;
Context—enhanced context, so that context is (a) clear, consistent and otherwise standardized to all senders, receivers, or accessors of a message and (b) determined from the outset for messages associated with work that the group is performing;
Containers—association of messages with containers wherein (i) containers preferably (a) are nested in two or more levels, and/or otherwise hierarchically related, (b) are variously identified as a project, discussion, activity, folder, action item, opportunity, effort or other work, particularly by a title, name or other denominator, the denominator preferably being public (at least to the group members) and being assigned in pursuit of such work, and (c) have organization/structure that is shared by group members on a particular project, if not everyone who could work on any project, and (ii) message association preferably is accomplished automatically in any response (i.e., association effectively being established before the message is otherwise created);
Addressing—addressing of messages to group members, so that messages arising from a group preferably are made available to all such group's members, while any particular message can be forwarded by a member outside such group, but preferably with certain controls (e.g., notification to and other communication with the group members, such as to/with all members or a project or discussion owner or other select member(s)), whereby splintering is controlled and/or precluded and messaging otherwise is kept transparent;
Participation—users joining, collaborating, participating or otherwise having access in or to the work through a response to an invitation, notice or other similar communication from the group (e.g., from any or selected group member(s)), such that users explicitly agree to participate and so that participation —as well as the lack of participation —may be tracked, so as to be substantially transparent;
Closure—association of due dates or other closure indicia with business objects, wherein (a) such due dates or other closure indicia preferably are explicitly assigned by the group, and (b) the framework preferably is enabled to track and flag to users the priority, status or other closure-related characteristic of any particular message or container, and to update same to users as such status may change (e.g., by changing among one or more colors, automatically), so that (i) group members are enabled to direct their contributions responsive to closure issues (e.g., group members may discern among or physical sort communications based on due date) and (ii) the framework facilitates management of closure;
Notification—provision of follow-up notification or other similar communication, e.g., so as to (a) notify other individuals who are not directly involved with the work group or its work and/or (b) provide a follow up mechanism that creates and sends a notification message, such as when a discussion is late or closed;
Lifecycle—establishing discussions as business objects, which objects have a lifecycle that is controllable by the original author and/or owner of the discussion (e.g., once a discussion is closed, the discussion preferably becomes an inert object for which further input is not accepted, unless the owner explicitly re-opens the discussion);
Organization—user's focusing or otherwise organizing their view(s) of messages and containers, such as through use of one or more filters, and preferably supported through meta-data associated with messages;
Discovery—discovery of resources available to the work group, which preferably is enabled throughout the solution, so as to (a) advance management, (b) enable group members to add new members by adding the new members' email or other communication address, and (c) enable both the tracking of who has been added and the association of each discovered user with the appropriate project; discovery is used to propagate project information throughout the work group;
Compatibility—communication with and otherwise contribution via extant systems (e.g., various selected, supported user clients, included from among the many extant email clients, wireless devices, handheld devices, browsers, etc.) so as to extend the reach of the solution, and thereby enable group members operating via such extant systems to participate in projects (e.g., through reports, as mere observers, or fully or otherwise);
Roles—defining roles, e.g., consistent with how roles arise, evolve and change in the pursuit and performance of the work (including, as examples, group member, contributor, project owner, manager and executive), with associated data views, tools and methodologies preferably being specifically designed for such role; and
Accountability—supports accountability, e.g., by establishing unambiguous expectations (due date) and context (project association and discussion ownership) thereby creating an environment where users can be fairly held accountable;
Reporting—users can peruse and drill into project communication with tools that provide context and filtering, access to communication is role based and generally is independent of having access at the time of the initial communication stream;
Agenda—tools for creating agendas and detailed agenda notes from existing communication in the solution;
Platform & Environment Independence—solution can be rendered on a variety of devices and environments, including, e.g., browsers, personal devices by the solution; the solution can be running on the local device or it can be served by a remote server;
Value at Every Level—value generation (e.g., return on investment) associated with members throughout the work group and, thus, in the organization, including (a) communication tools and methodologies for contributors, (b) agenda, organization and accountability tools for project managers, and (c) metric tools and methodologies for executives.

The various features of novelty which characterize the invention are pointed out with particularity in the claims annexed to and forming a part of this specification. For a better understanding of the invention, its operating advantages and specific objects attained by its use, reference should be made to the accompanying drawings and descriptive matter in which its preferred embodiments are illustrated and described, wherein like reference numerals identify the same or similar elements.

### DESCRIPTION OF THE DRAWINGS

The invention can be better understood with reference to the following detailed description together with the appended illustrative drawings in which like elements are numbered the same:

FIG. 1A is a screen shot illustrating an example embodiment of a solution, in accordance with the present invention;

FIG. 1B is a screen shot illustrating the example embodiment of FIG. 1A, in accordance with the present invention;

FIG. 1C is a screen shot illustrating the example embodiment of FIG. 1A, in accordance with the present invention;

FIG. 2A is a screen shot illustrating the example embodiment of FIG. 1A, in accordance with the present invention;

FIG. 2B is a screen shot illustrating the example embodiment of FIG. 2A, in accordance with the present invention;

FIG. 2C is a screen shot illustrating the example embodiment of FIG. 2A, in accordance with the present invention;

FIG. 2D is a screen shot illustrating another example embodiment of a solution, in accordance with the present invention;

FIG. 3A is a screen shot illustrating the example embodiment of FIG. 1A, in accordance with the present invention;

FIG. 3B is a screen shot illustrating the example embodiment of FIG. 3A, in accordance with the present invention;

FIG. 3C is a screen shot illustrating the example embodiment of FIG. 3B, in accordance with the present invention;

FIG. 4A is a screen shot illustrating the example embodiment of FIG. 1A, in accordance with the present invention;

FIG. 4B is a screen shot illustrating the example embodiment of FIG. 4A, in accordance with the present invention;

FIG. 4C is a screen shot illustrating the example embodiment of FIG. 4A, in accordance with the present invention;

FIG. 4D is a screen shot illustrating the example embodiment of FIG. 4A, in accordance with the present invention;

FIG. 4E is a screen shot illustrating an example embodiment of a solution, in accordance with the present invention;

FIG. 4F is a screen shot illustrating an example embodiment of a solution, in accordance with the present invention;

FIG. 5A is a screen displayed when a user actuates functionality depicted in FIG. 4A, in accordance with the present invention;

FIG. 5B is a screen displayed when a user actuates functionality depicted in FIG. 5A, in accordance with the present invention;

FIG. 6A is a screen displayed when a user elects to create a new project via actuation of functionality depicted in FIG. 1A, in accordance with the present invention;

FIG. 6B is an alternative implementation of functionality associated with creating a new project, accordance with the present invention;

FIG. 7 is a screen displayed when a user elects to create a new discussion via actuation of functionality depicted in FIG. 1A, in accordance with the present invention;

FIG. 8A depicts an example notification email message, in accordance with the present invention;

FIG. 8B depicts a notification sent to a user when a specific condition is met, in accordance with the present invention;

FIG. 9A depicts an example project report that might be available to a manager or executive using the solution, in accordance with the present invention;

FIG. 9B depicts an example process report for a blocked project, in accordance with the present invention; and

FIG. 10 depicts an example deployment configuration for the solution, in accordance with the present invention.

### DETAILED DESCRIPTION

The present invention is directed to software features, functions, applications, tools, systems, methods and other solutions in business communication. In the descriptions of various embodiments according to the invention, various terms may be used, including the following:
a) “Project”, “opportunity”, “effort”, “folder”, “challenge”, “initiative” and similar terms may be variously used to describe work to be pursued, performed or otherwise undertaken by a group.
b) “Discussion”, “component effort”, “task”, “action item”, “activity”, “file”, and similar terms may be variously used to describe work to be pursued, performed or otherwise undertaken by a group, or part of a group, that is a portion of a project or other higher level container, whether that portion is small, large or the entirety of the project.
c) “Work”, “effort” and other similar terms may be variously used to describe either or both projects or discussions, which meaning is determined by the context of use.
d) “Group”, “work group”, “team”, “work team”, “project team”, “virtual team”, “dynamic team”, “distributed team” and similar terms may be variously used to describe the set of people that work in a task force, team, organization, associations, assembly, group, or other similar construct. As an example, even if one person ostensibly works alone, their work tends to engender either/both (a) input from and/or output to other people, groups and entities and/or (b) a variety of reporting lines (both solid and dotted), responsibilities, authorities, hierarchies, and other connections with other persons, groups and entities. It is understood, but neither a requirement nor a restriction on the solutions set forth herein or their use, that work groups can describe a group of people that are subject to any (or none) of the following, or other, parameters: (i) the members of a group may be large or small in number, diverse in skill-sets or otherwise; (ii) while group members may be located together, or at least in the same building, they may also be located in various buildings, which buildings may be in one or more complexes, perhaps dispersed geographically across a town, city, state, country, continent, hemisphere or, often, over various locations that can be worldwide; (iii) members may or may not ever have met each other and may or may not ever meet each other; (iv) members' physical location may not be known or may not ever come to be known; (v) group members may have the same or differing reporting paths, perhaps being in different hierarchies in a company; (vi) group members may be from different companies, which companies may be affiliated, joint venturing, or completely independent; (vi) the group may change, as to members, in identity, number, skills and otherwise; (vii) over time, changes may arise in the project and/or discussion, responsive as, e.g., component efforts, action items and other tasks become identified, defined, clarified, understood, redefined and otherwise evolve; (viii) deadlines associated with the work also may change, over time, again as component efforts, action items and other tasks become identified, clarified, understood, and evolve and/or and get re-ordered, delayed, stalled, blocked, or (in whole or in part) completed; (ix) any group member may have different responsibilities, authorities and expertise within a project and, thus, have varying roles on a discussion-to-discussion within that project; and (x) any group member may be simultaneously involved in one or more other projects, wherein any such other project may, but need not, have one or more group members in common with such first project. e) “Member”, “group member”, “team member”, “participant”, “constituent”, “contributor”, “user”, “author”, “owner” and other similar terms are variously used to describe a person that is associated with a work group, such as to pursue, perform, join in, contribute, collaborate on, participate, or otherwise work on or take a role in relation to a project or a discussion thereof, and/or so as to access, assemble, review or otherwise use messages, information or other data associated with a project or a discussion thereof. As a non-exhaustive example, a member may comprise a manager of one or more members or of projects who provides no contribution to the pursuit or performance of a particular project or any discussion thereof, but has access, supervision and other oversight, so as to assess quality, status, progress or other aspects of the project and/or to evaluate each member's performance. Some of these terms may connote specific roles within the solution (e.g., an owner may be responsible for a project), which connotation should be evident from the context in which the term is used. In an example embodiment accordingly to the invention, tools, methodologies, systems and other solutions build on the metaphors associated with email. Preferably, in this example embodiment, the solution also is enabled to interoperate with email systems.

In an example embodiment of a solution, various features and functionalities may be implemented, or not, in accordance with the principles of the invention. Some of these features and functionalities, as contemplated, include, by example and without exhaustion:

A) Accountability and Responsibility—the solution preferably enforces accountability and responsibility in multiple dimensions.

As to discussions, the solution may be implemented to enforce accountability and responsibility in various ways. Examples include the following:
Ownership—discussions sent using the solution have clear ownership. The initiator of the discussion is clearly identified.
Participation—the solution tracks responses and lack of responses. For any given discussion, the solution structures the data in such a way that it (i) enables reporting on, for example, who has responded to the discussion and the number of times a user has responded, and (ii) supports filtering responses based on users.
Lack of Participation—the solution tracks who has not responded.
Responsibility—the owner bears responsibility for setting the due date (or not, as setting a date may be optional) and determining when the discussion should be completed.

As to projects, the solution may be implemented to enforce accountability and responsibility in various ways. Examples include implementing project ownership and project due date.

The organization and storage of selected data relating to communication enables support for various features that implement accountability and responsibility, e.g. tracking the number of replies a user submitted respecting a discussion, identifying the users who have not responded, providing tools to close discussions and projects, etc.

Applying ownership to communication is facilitated by the solution storing communication data. In an example embodiment, the solution stores discussions and associated replies as separate elements in the solution database. Each element is time stamped and identified with the author who is the owner of the entry. Furthermore, the solution tags each entry with meta-data that describes the entry, e.g. discussion forwarded, discussion closed.

The solution preferably uses meta-data to various ends. For example, metadata may be used as follows:
What needs to be done is contained in one discussion with an explicit status
When it needs to be done is clearly communicated via the due date
Who is involved is explicitly communicated

As such, the solution is directed to create an environment where accountability and responsibility are enhanced, e.g., can be applied fairly and effectively.

B) Work Administration and Work Process—the solution preferably enables organizing and managing communication from multiple points in the solution.

In an example embodiment, the solution's organizational metaphor is based on a hierarchical containment model. Moreover, the solution is typically implemented to support primitive containment structures that are built into the solution. While the primitive containment structures may be variously implemented, generally such structures comprise discussions and projects. As well, a particular solution may be implemented to also support user-defined containment structures. While user-defined containment structures may be variously implementable, generally such structures comprise one or more folder structures, disposed in the containment hierarchy between discussions and projects.

In a typical embodiment, projects contain a collection of related discussions. Moreover, projects generally have associated functionality that enables managing and organizing the contained discussions. Typically, projects may be characterized based on one or more of the following
Projects have one owner.
Projects have a status and optional due date.

As well, in a typical embodiment, discussions contain related messages. Moreover, discussions generally have associated functionality that enables managing and organizing the contained messages. Typically, discussions may be characterized based on one or more of the following:
Discussions have a status and optional due date.
Discussions may be associated with projects. While this association may be with plural projects, the association typically has at least one project (e.g., one project total or one primary project).
When the solution receives a reply to a discussion, the solution time stamps it, associates it with its author and associates it with the discussion.

The solution preferably is implemented to create a default project for a user (e.g., “Personal Projects”). This default project typically is established at the time that the user's account is created in the solution. Default projects generally are kept private, so that they are visible only to the project owner. As an example, a default project may be created as follows: when a user creates a discussion without an explicit project association, the solution preferably automatically associates the discussion with the user's default project. In this example, the solution preferably enables the user to later re-assign the discussion to another project. Work administration preferably is layered on discussions and projects. Work administration typically provides tools for managing, controlling and otherwise handling discussions and projects. Work administration may be variously implemented. In an example implementation, work administration includes tools and functionality that include:
Creating, closing and re-opening discussions—when a discussion is closed, the solution can be configured to shut down the discussion. Shutting down the discussion generally would preclude the participants from normally replying in the discussion, which preclusion would extend to individuals accessing the discussion using channels outside the solution (e.g., via email). In particular example embodiments, the preclusion would bar any reply by any user, or enable replies by certain users, or enable a limited form of reply (e.g., one that is not credited with being timely, etc.), or the like.
Implementing a discussion shut down functionality affords various advantages, which advantages may vary depending on the reach of the shut down. As an example, for the owner of the discussion, the shut down functionality provides enhanced authority to manage the discussion, ultimately toward bringing the discussion to closure. As another example, for participants in a discussion, the shut down functionality reinforces accountability, e.g., by making due dates enforceable.
This capability may not be variously implemented in the solution. As an example, it may be omitted for certain discussions, e.g., discussions that are, by definition, open-ended generally will not be closed and, as such, may benefit from the solution not enabling such closure.
For these open-ended and other no-close discussions, the solution may be implemented to support alternative capabilities. As an example, the solution may display the discussion less prominently in the user interface. The solution may also age discussions, e.g., based on the frequency of replies to the discussion. It is noted that discussions handled this way may be absent a due date.
Moving discussions between projects—the solution typically enables an owner to move discussion from one project to another. Thereby, a user may organize and re-organize projects as the projects evolve. When a discussion is moved from one project to another, replies to the discussion are automatically routed to the moved discussion. Thereby, users may focus on high level organization, rather than on mechanics of organizing replies.
Projects can be created, closed and re-opened—when a project is closed, discussions in the project typically are automatically closed by the solution.
Setting project visibility (public/private)—enables owners to control whether a project is visible from the solution's reporting system. At any point during the project's lifecycle (e.g., from creation onward), the owner preferably is enabled to set and re-set project visibility.

In an example, embodiment, the solution supports general-purpose folders for organizing projects. Such folders may be variously implemented. Generally, it is contemplated to support two types of general-purpose folders:
Domain level—to organize projects and other domain level folders. These folders may typically be used, as examples, (i) to collect projects in such folder (e.g., to create a Program of smaller projects) and/or (ii) to represent organizational hierarchy (e.g. contain projects and programs by region(s)).
Project level—to organize multiple discussions and/or other project level folders. These folders may typically be used as projects grow larger so as to enhance the organization of various discussions and/or to provide views into discussion data.

Work process preferably is also layered on discussions and/or projects. Work process typically provides tools for organizing, controlling and otherwise handling the process associated with discussions and/or projects.

Work process may be variously implemented. In a typical embodiment, work process is contemplated to borrow aspects from basic checklists/to-do lists up to and including complex workflow systems. Therein, work process enables the user to define a structure for pursuing a project or discussion.

In an example implementation, work process contemplates one or more tasks, where each task may contain one or more steps. In turn, a step may have any of the following attributes:
Each step may be a simple, focused effort for completing work.
Each step may have a completion status, e.g. not started, in progress, completed, warning, blocked.
Each step may have a description describing work to be done or how it is to be done or otherwise.
Each step may have a help function, e.g. an On Line Help providing context-sensitive, detailed instruction.
Each step may use existing MS Office documents, e.g. Word, Visio, Excel, Word Perfect, to implement the process and to embed the complexity of the process in these documents.
Each step may be associated with a set of templates for completing work. These templates can include content for messages, outlines for documents, etc. Templates can leverage MS Office documents.
Each step may be associated with a completed document(s) that can represent the completed work.
Each step may be associated with multiple discussions—which can capture the communication surrounding the completion of the step.
Each step may be optional or mandatory.
Steps may be with or without sequence.

In a typical embodiment, steps are organized into tasks. There, while steps represent specific units of work, each task generally represents a higher-level goal. It is understood, however, that solutions may have other hierarchies in process structure (e.g., sub-steps, steps without tasks, etc.), without departing from the principles of the invention.

Generally, the process hierarchy is implemented to support scheduling. In a typical embodiment, steps and tasks support scheduling. Both structures can have duration or a due date associated with them. When steps and tasks are not completed in the scheduled time, the system may generate a notification event (e.g., signifying that such step/task has not completed on schedule).

The solution may be variously implemented as to both work administration and work process. In particular embodiments, for example, one or more of the following may be supported:
A project may reside in multiple domain folders.
A project may contain multiple project folders.
A discussion may be in multiple project folders.
Projects can have zero or more work processes associated with them.
Discussions can be associated with multiple steps.

Generally, the solution supports providing individuals with visibility into projects which they do not own and in which they do not participate actively. The solution typically grants these users read-only privilege; however, the solution may be implemented even to grant these users read/write privileges. Visibility privileges may be variously implemented. As examples, these privileges may be provided at multiple levels, including:
Project—view all discussions in the project
Project folders—view all discussions in a specific folder
Work Process—view the project data thru a specific work process

Provision of such views into a project, particularly in enterprise situations, may be used to enable appropriate insight into the work (e.g., customers can gauge progress in a development project, without being able to determine the technological underpinnings). That is, through privileges, views may comprise controllable project portals for use by individuals inside and outside of the organization.

Generally, the solution is flexible and allows users to work with the system in many ways. In an example implementation, the solution enables users to start communicating using email or a solution application before creating a project associated with the effort. The system typically is implemented toward encouraging users to start communicating and solving problems, rather than focusing the users on determining the appropriate organizational structure for the work. For example, if a user does not initially create a project to contain communications, the communications typically are placed in a default project. At any point, as appropriate, the user can create a project and move the discussions into the project. Thereby, the solution enables users to apply organizational structure when and as they need or desire it. Similarly, the solution supports associating work processes with a project at any time during a project's lifecycle.

The application also supports sending messages to the solution from email. These messages generally are collected and managed by the solution as if the message was originated within the solution's system (e.g., by a dedicated solution client or by a thin client accessing the solution's server system). Typically, messages that originate outside of the solution are associated with a default project and, at a later time, a user can move the discussion to an appropriate project.

C) Email Interoperability—generally, the solution supports interoperation with standard email. More generally, the solution preferably enables users to exploit the solution using a thick client (e.g., local solution functionality and/or a synchronized portion of the solution's database as is relevant to the user's access to the solution), any web client directed to link into the solution's server system, any off-the-shelf email clients communicating with the solution's server system, or any other channel which similarly is supported by the solution's server system. To do so, the solution's server system performs various tasks, including: interpreting a message received via any such channel; associating the message with the appropriate discussion; updating the solution database; and creating and sending update email messages to all implicated users.

In sending email to email clients, the solution preferably encodes a unique identifier into the email which identifier enables the solution to track communication with each user via their email clients. The unique identifiers may be variously implemented and variously encoded, without deviating from the principles of the invention. An example is the reference number 258 described below.

In operation, the solution tracks outstanding email messages. When a message is received, the solution seeks to match, via the unique identifier, the received message with the messages it has sent out. In doing so, the solution preferably verifies that the user sending the message is authorized, that the discussion to which the email is associated continues to be accepting replies and that the communication is otherwise valid. Moreover, the solution parses the email to isolate content that the user has added. The solution adds the new content to the appropriate discussion and otherwise updates the solution's database. After updating the database, the solution publishes a consolidated message (i.e., organizes and formats all replies received since the previous publication) to all implicated users, via the various supported channels for each user, as appropriate.

The solution supports extending existing third party email clients to support solution functionality, including creating, sending and managing discussions and projects. The solution also supports integrating thin client browser based solution functionality into third party email clients.

The solution generally is contemplated to defeat, discourage or otherwise impede splintering of discussions into multiple threads. Any replies received by the solution are integrated into the overall discussion.
D) Attachments—the solution preferably manages attachments being sent between users. In an example embodiment, when a user sends an attachment using email or from the solution's user interface (either thick client or browser based solution), the system copies the attachment to a specific project directory and replaces all correspondence with a URL that points to the attachment.
Attachments typically are available from any solution client or from an email client. The solution associates the attachment with the discussion it was sent in. The solution also records who sent the attachment and when it was sent. The solution provides various tools for viewing all documents associated with a project, and for viewing the attachment in context of the original discussion.
E) Discovery—as discussions are created and sent to multiple individuals inside of and outside of the organization, the system automatically tracks who has been asked to participate and their specific responses. This mechanism is used, e.g., in the project functionality to list all of the individuals who have interacted with the project.

The solution typically also uses this mechanism to determine which projects a specific user can view. As users are added to discussions, the solution automatically adds them to the project—allowing them to create new discussions within the project and view project overview information. If a user is using the solution with a local database, the database is automatically updated with the appropriate project information.

E) Notification—the solution generally supports creating triggers that send notification information to users when specific conditions are met. For example, the system can examine the following data to execute various triggers:
Due Dates on any object in the system—discussion, project, set in a work process
Participation data—e.g. trigger when 90% of the recipients have responded or when the CEO and COO reply
Warning and Block conditions—based on user defined work process status
User Defined Attributes—on projects and discussions can also drive notification

The solution supports sending notifications on multiple channels including but not limited to email, voice messages, pager messages, instant message messages, etc. The solution also typically tracks when notifications have been sent. The notifications can be variously implemented, including, e.g., to support links to the solution's reporting system and/or to the solution application. The links can take the user to the solution objects that triggered the notification or to other user specifiable part of the solution.

F) Reporting—the solution generally supports making collaboration, organizational and process information available to users via a reporting system. The reporting system typically accesses the same database that the solution uses to track all communication in the system. Since the reporting system uses the same database, reported data generally is real-time. The solution preferably supports various querying of the data.

G) Data Organization—the solution supports use of business objects in implementing functionality. Examples of business objects include:
Domains—typically are the highest-level organizational objects in the system. Domains generally correspond to an enterprise, a division or department. The application attaches to a specific domain to retrieve and send communication data.
Projects—typically are the highest-level organizational objects within a given domain.
Person—objects represent users in the system. Person object can own projects, discussions, replies, agendas and attachments.
Discussions—typically are containers for messages between/among users.
Commentary—objects represent user replies to a discussion. Each reply is stored in a separate record in the database, is time stamped, identifies the author and characterizes the type of commentary. When discussion meta-data is changed, the system records the change in meta-data using a commentary object. For example, when due date is changed, the system updates the information in the discussion object and creates a commentary object which identifies the new date, includes the user's comment (if any) and sets the commentary type to change date.
Folders—generally are generic containment objects. A folder supports nesting (e.g., unlimited) and can be surfaced in the user interface as project folders and domain folders.

H) One Global Data Base with Selectable Views—the solution typically supports centralizing communication information in one database. This database preferably can be replicated to support multiple solution servers. The database preferably can also be replicated to local databases for access by a thick client application.

Data typically is viewable from various, selectable views and perspectives. Users who were not directly involved in the discussions or projects typically are enabled to view all of the communication data. The views available to a specific user may be implemented responsive to their role. Roles typically are user definable.

I) Multiple platforms and multiple devices—the solution is contemplated to be implementable on and to support various platforms and devices. As an example, the solution is contemplated to be implemented via dedicated, thick clients having local replicas of the solution database (e.g., relevant portions of such database) and/or via a general-purpose, browser client that links to the solution's server system (e.g., absent a local database).

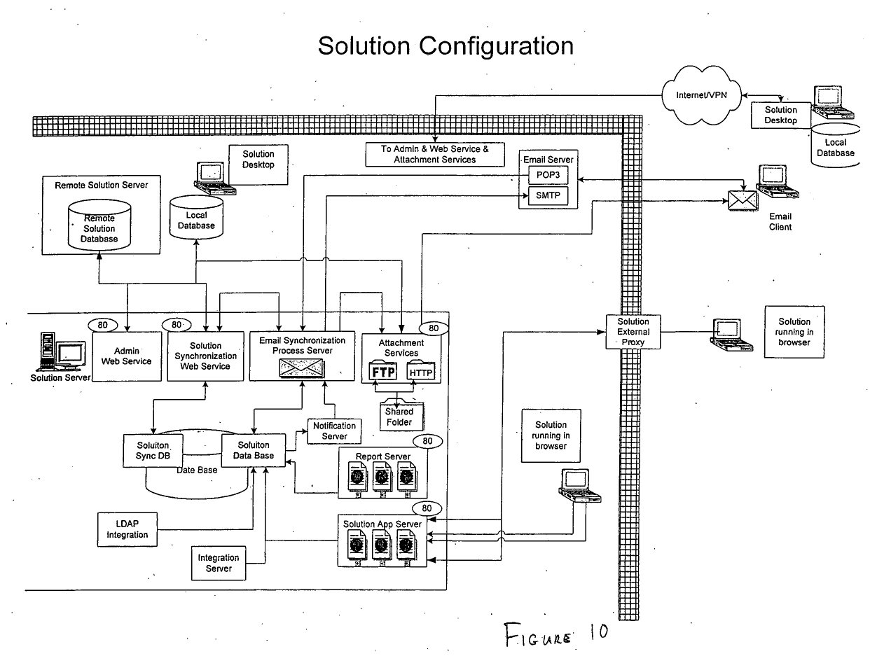

As another example, the solution is contemplated to be implemented via a peer-to-peer deployments (e.g., where each user runs a local database). In the architecture described below with reference to FIG. 10, the synchronization data is sent to other databases, e.g., on an as-needed basis, by a Synchronization Web Service. In a peer-to-peer implementation, this approach would be expanded so that each node would run a Synchronization Web Service. In the alternative, the Synchronization Web Service can be deployed as a relay server.

The solution is also contemplated to support mixed deployments. That is, deployments having, at once, any of (a) a local databases for a thick client which replicates with a remote, shared database, (b) a local database for a peer to peer client, which distributes data among other local databases for other peer to peer clients, and/or (c) a remote, shared databases accessed by clients which do not exploit a local database (e.g., browser functionality). Combinations of these may be implemented even for a single user so that the user may have various channels by which to exploit the solution's functionality.

The solution preferably also is implemented to interoperate with standard email, as previously described.

The solution preferably also is implemented to support peer-to-peer deployments (e.g., where each user runs a local database). The solution's underlying data model contains metadata sufficient to determine distribution/communication of the data.

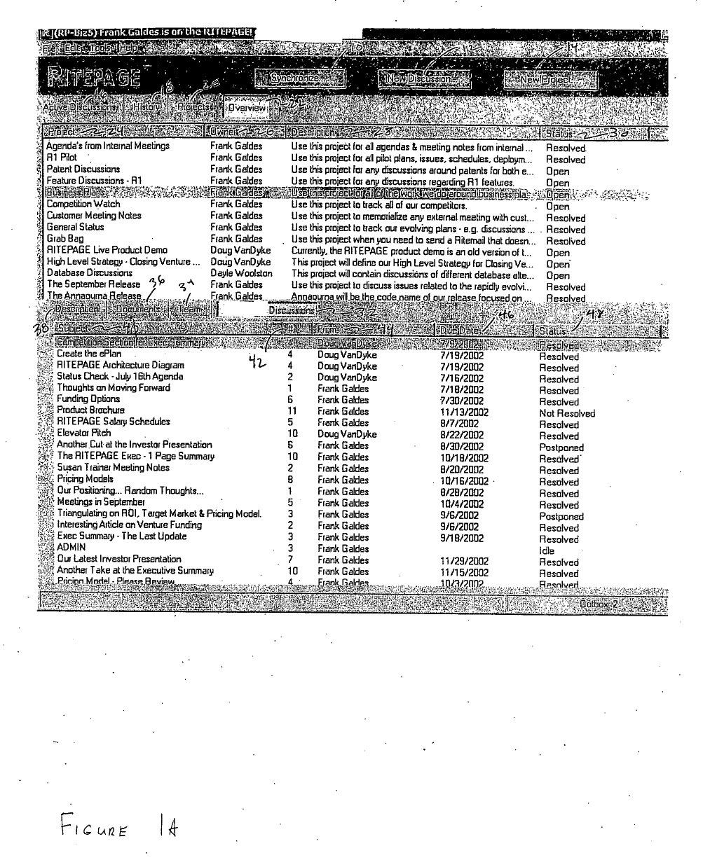

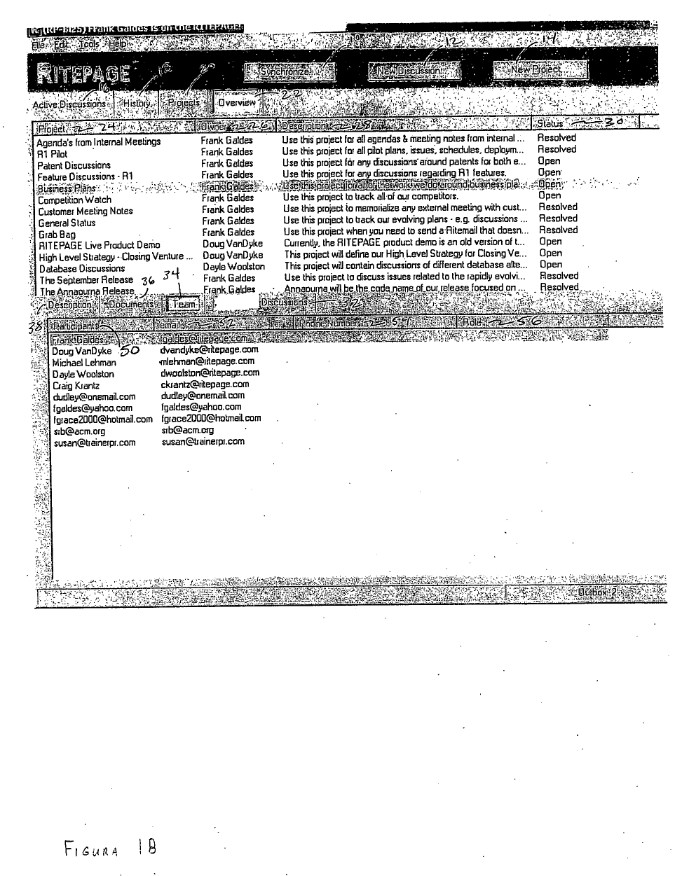

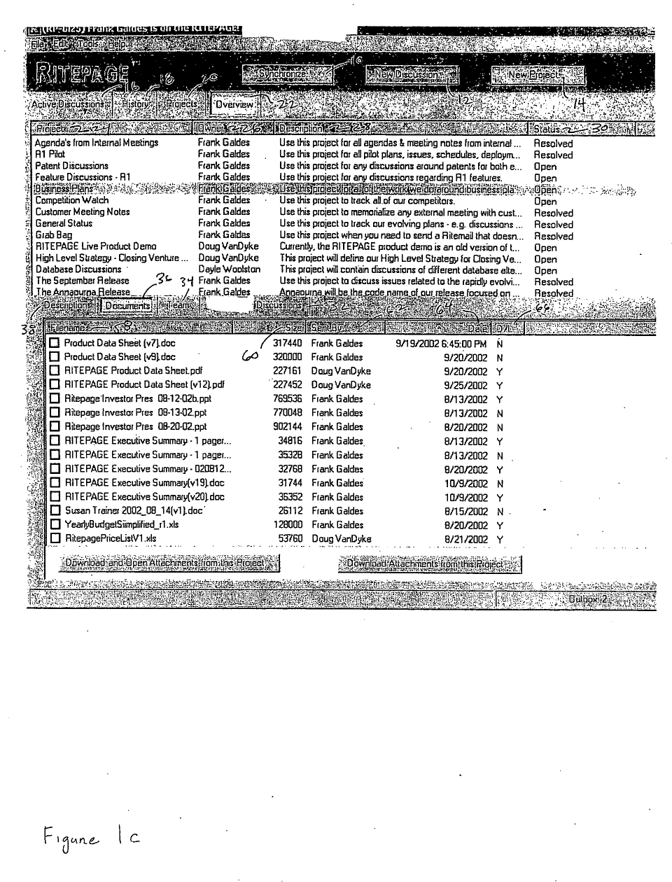

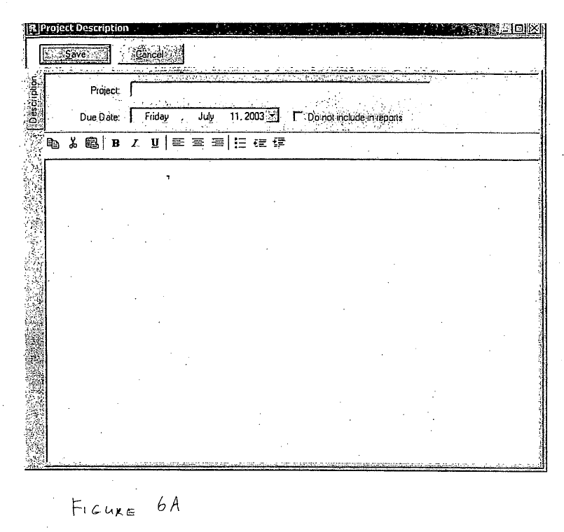

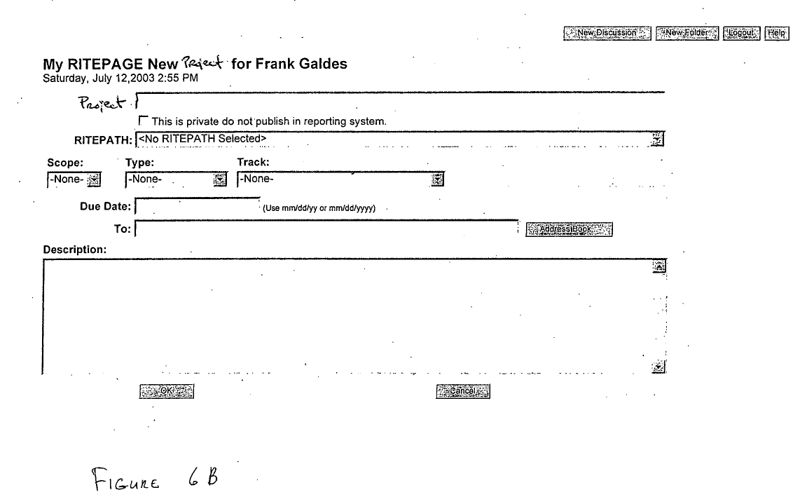

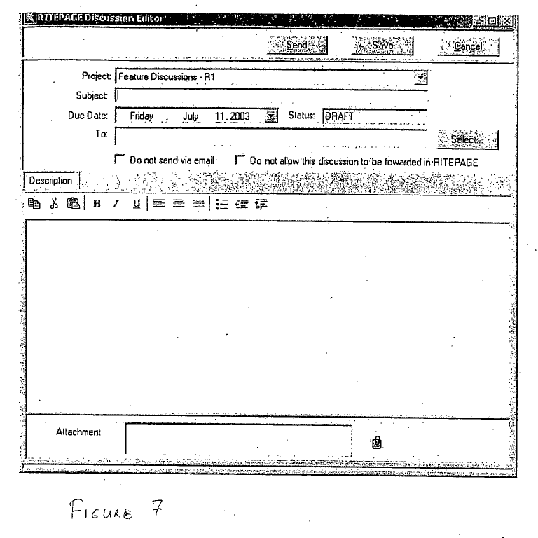

FIG. 1A is a screen shot illustrating an example embodiment of a solution as contemplated by the present invention. In this example embodiment, it is contemplated to support various high level administrative functions. As examples, here, three buttons 10, 12, 14 at the top of the screen shot provide selected, examples of supported administrative functionality:
Synchronize 10—available in a thick client implementation, sends and receives messages between local solution and solution server.
New Discussion 12—displays the new discussion dialog, see FIG. 7.
New Project 14—displays the new project dialog, see FIG. 6.

It is contemplated to provide one or more views of data supported by the solution. In this example embodiment, four tabs 16, 18, 20, 22 provide selected views of the solution data:
Active Discussions 16—data relating to active discussions being managed by the solution that the user is associated with.
History 18—data relating to discussions the user has been associated with, including, e.g., active and non-active discussions.
Projects 20—data relating to projects of the user.
Overview 22—data relating to projects the user is working on or has worked on (e.g., all projects). (In FIG. 1A, this Overview tab is selected.)

The views provided generally are either/both an implementation option and/or a configuration option (e.g., selecting the Projects tab 20 to show all projects that the user is associated with, rather than only those that the user owns). It is understood that these and/or other views may be provided without deviating from the principles of the invention.

In this example embodiment, these views are at the level of the containers of the embodiment. Here, the containers include projects and discussions. In one aspect (for the purposes of describing this Figure), a project comprises one or more discussions, while discussions comprise one or more messages. Generally, container(s) used in any particular embodiment are either/both an implementation option and/or a configuration option. It is understood that other container(s) may be used without deviating from the principles of the invention.

When Overview tab 22 is selected, it is contemplated to display one or more projects. More specifically, it is contemplated to display data that characterize, describe or otherwise give access to one or more projects. In this example embodiment, data is displayed relating to all projects the user is working on or has worked on. Also in this example embodiment, projects are displayed as a list, with data for each project displayed in the upper panel of the screen shot under various categories. Here, selected, example categories, as shown, include:
Project 24—project name or other denominator
Owner 26—name of project owner
Description 28—project description
Status 30—project status (generally, any of various pre-determined indicia of the current status of a project)

The categories supported (as well as the implementation aspects thereof, e.g., status indicia) generally are either/both an implementation option and/or a configuration option. It is understood that these and/or other categories may be supported without deviating from the principles of the invention. Similarly, the criteria for selecting the data to be displayed may be otherwise provided (e.g., data for the Overview view may be restricted to only current projects of the user and/or to only projects that the user owns), which criteria generally are either/both an implementation option and/or a configuration option.

Note, however, that such option(s) preferably are selected in light of the selections associated with other supported views, e.g., the view associated with the Projects tab 20. By coordinating views, a user preferably is enabled to display, by using the provided views, their projects in a structured manner, to enhance efficiency or otherwise to obtain advantage. As an example, the Overview view may be implemented to enable view of all projects the user has ever been in any way involved with (e.g., even as a specific access user), while the Projects view may be implemented to enable view of current projects (e.g., such as with folders or filters to enable sub-views of only those projects owned by the user or only those owned by others).

It is contemplated to provide one or more sets of options by which to enable a user to access, display, manage, or otherwise use data supported by the solution. Preferably, these options (and the functionality they represent) respond to the views that are provided. To illustrate, for this example embodiment, options responding to selection of Overview tab 22 are provided via tabs 32, 34, 36, 38 disposed in the lower panel of the screen shot. By selecting of any such tab 32-38, a user drills into data relating to the project selected in the upper panel, as made available by selection of Overview tab 22.

Here, Discussions tab 32 is selected for Overview tab 22. When Discussions tab 32 is selected, it is contemplated to display one or more discussions relating to the project. More specifically, it is contemplated to display data that characterize, describe or otherwise give access to one or more discussions. In this example embodiment, discussions are displayed as a list, with data for each discussion displayed in the lower panel of the screen shot.

Specifically, here, selection of Discussions tab 32 results in display of a list of discussions associated with the project having the denominator “Business Plans”, as such project is selected in the upper panel. In this example embodiment, the user views all of the discussions to which they have access. It is understood that the list can be otherwise displayed, without deviating from the principles of the invention, which listing may be either/both an implementation option and/or a configuration option.

In this example embodiment, data for each listed discussion is displayed under various categories. Here, selected, example categories, as shown, include:
Subject 40—discussion subject or other denominator
# 42—Number of replies, messages or other tracked activities associated with the discussion
From 44—discussion owner
Due Date 46—the date the discussion is due
Status 48—the status of the discussion (generally, any of various pre-determined indicia of the current status of the discussion)

The categories supported (as well as the implementation aspects thereof, e.g., status indicia) generally are either/both an implementation option and/or a configuration option. It is understood that these and/or other categories may be supported without deviating from the principles of the invention.

FIG. 1B is a screen shot illustrating the example embodiment of FIG. 1A, showing solution data displayed upon selection of the Team tab 34 for Overview tab 22. When this Team tab 34 is selected, it is contemplated to display data relating to group members associated with the selected project. More specifically, it is contemplated to display data that characterize, describe or otherwise give access to one or more group members associated with the selected projects.

As to identification, the solution automatically builds the work group (note that this concept of discovery is described further elsewhere herein). In one example embodiment, the solution may build a work group by the group members who are now working on, have in the past worked on or have ever been invited to work on (but have not worked on) on the selected project. In another example embodiment, the solution may build a work group based on one or more of the above criteria (e.g., only currently active members). It is understood that that the solution may build work groups in various other ways, without deviating from the principles of the invention, which group building may be either/both an implementation option and/or a configuration option.

In this example embodiment, the solution builds the group based on who has been asked to participate in the discussions associated with the selected project and, then, filters or enables filtering of such information based on various criteria, including current participation, past participation, discussion breadth, messaging volume, etc. In addition, the solution preferably also is enabled to include person(s) who have been given specific access to the selected project For example, such access may be given to a manager of one of the users or to someone who has business responsibility to which the project is relevant. It is understood that any one or more of such building of the work group, such inclusion of specific access persons and such filtering may be either/both an implementation option and/or a configuration option (e.g., the solution, a system administrator, owner of a project/discussion, or a user may enable or chose to identify any particular, specific access person by the type of role they play), without deviating from the principles of the invention.

In this example embodiment, data as to group members is displayed as a list in the lower panel of the screen shot. Data for each listed group member is displayed under various categories. Here, selected, example categories, as shown, include:
Participant 50—name of an individual in the group
email 52—email address of an individual in the group
Phone Number 54—phone number of an individual in the group—can be retrieved from external sources
Role 56—role of an individual in the work group (which information may be retrieved from within the solution or from external sources)

The selected categories may, as previously stated, have associated therewith various filtering capabilities (e.g., so as to enable a user find all specific access individuals). In addition, the selected categories may be implemented to provide selected access (e.g., via hot links, menus or otherwise) to additional data relating to the identified individual as such data is tracked by the solution. In respect of this access, for example, a user may be enabled through the solution to associate a particular, identified group member to data discussions generally (e.g., within the current project or otherwise), to active discussions, to invitations to discussions, to rejections of invitations, to messages replied to within a project/discussion, to all or selected discussions forwarded outside the work group and to other data tracked by metadata, as well as to metrics related to this and other information (e.g., number of messages sent in a particular project/discussion, such as to determine the activity level of the identified person, over a relevant time frame).

FIG. 1C is a screen shot illustrating the example embodiment of FIG. 1A, showing solution data displayed upon selection of the Documents tab 36 for Overview tab 22. When this Documents tab 36 is selected, it is contemplated to display data relating to documents associated with the selected project. More specifically, it is contemplated to display data that characterize, describe or otherwise give access to one or more documents associated with the selected project.

Generally, the solution may variously associate documents to folders. As an example, the solution may associate documents that are attachments in any message of a discussion of the selected project, whether that message is sent via email, via a thick client implementing the solution, via a thin client implementing the solution, via a peer-to-peer client implementing the solution or through some other channel that either implements or communicates with the solution. Preferably, the solution performs this association automatically.

In this example embodiment, data as to documents is displayed under various categories. Here, selected, example categories, as shown, include:
Filename 58—the name of the file that was sent
Size 60—the size of the file
Sent By 62—identifies which group member sent the file
Date 64—the date and time the file was sent
D/L 66—for thick client, identifies if the file has been downloaded or otherwise retrieved and is available locally.

The categories supported (as well as the implementation aspects thereof, e.g., D/L for a thick client implementation) generally are either/both an implementation option and/or a configuration option. It is understood that these and/or other categories may be supported without deviating from the principles of the invention.

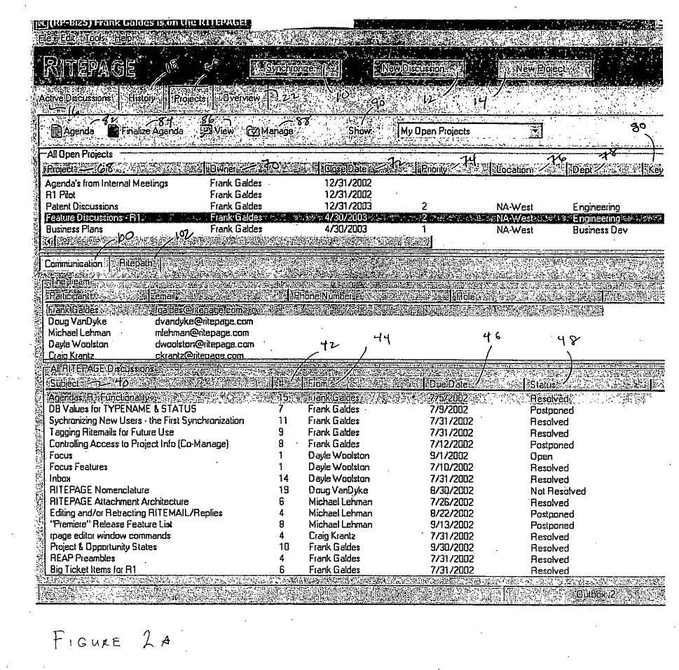

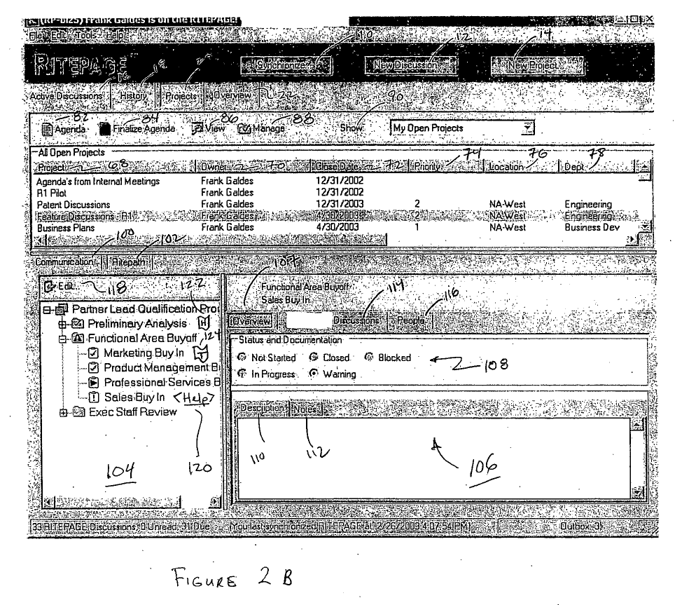

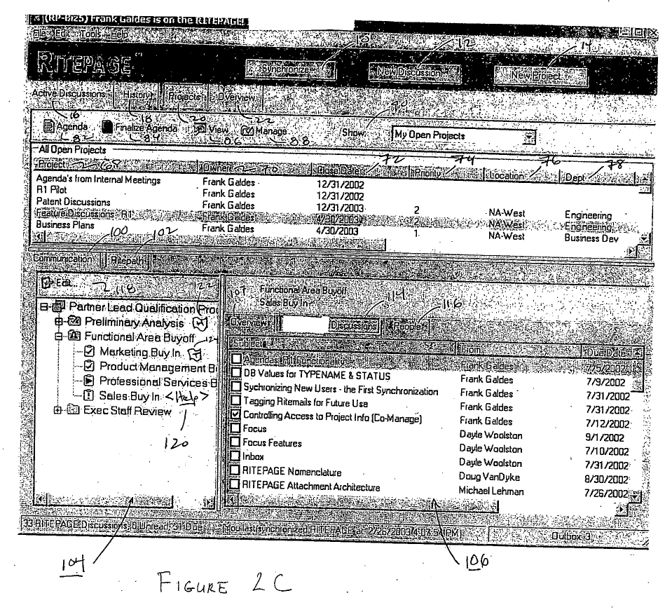

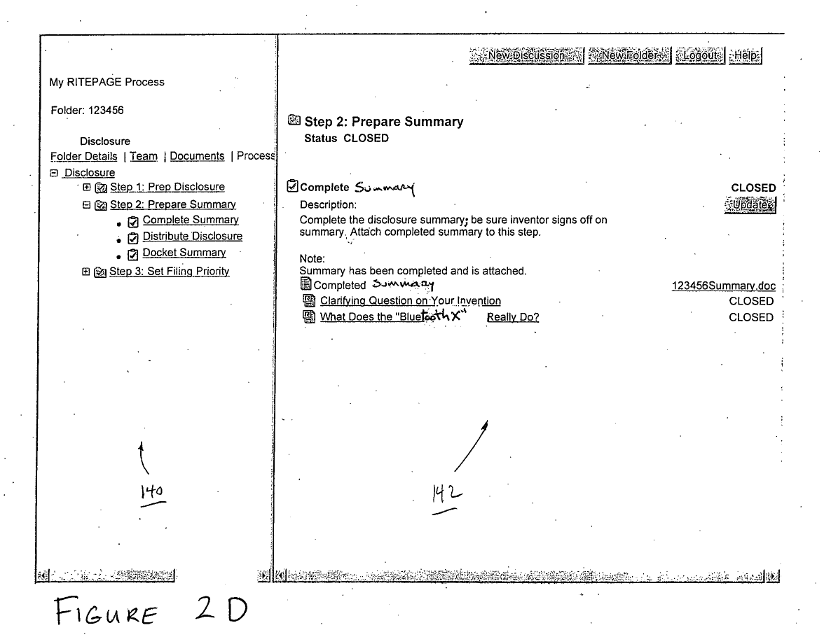

FIG. 2A is a screen shot illustrating the example embodiment of FIG. 1A, showing solution data displayed upon selection of Projects tab 20 (i.e., rather than Overview tab 22). When Projects tab 20 is selected, it is contemplated to display one or more projects relating to the user. More specifically, it is contemplated to display data that characterize, describe or otherwise give access to one or more of such projects.

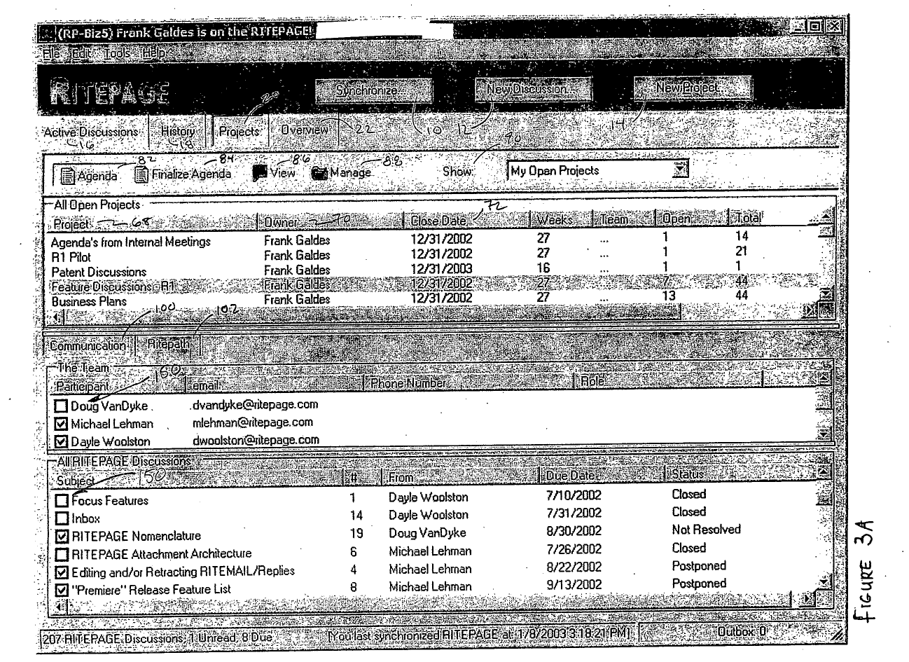

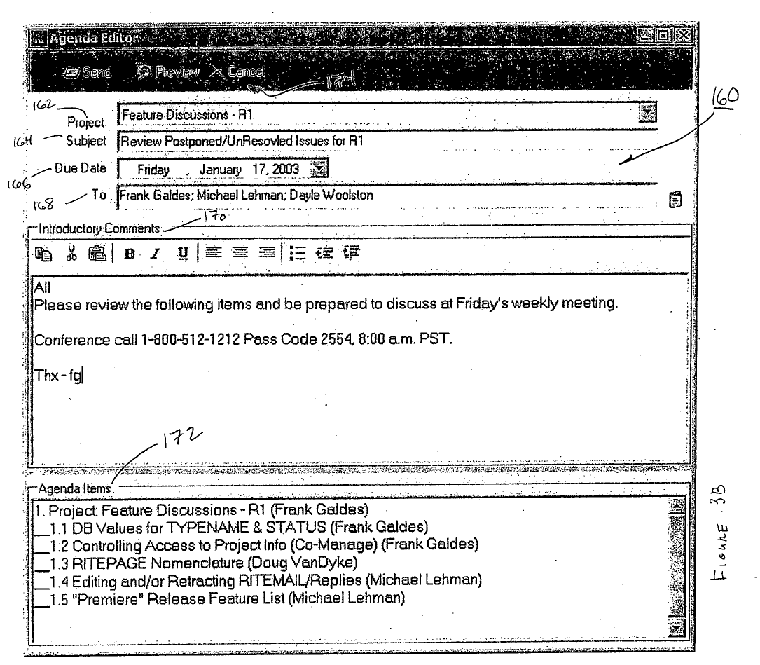

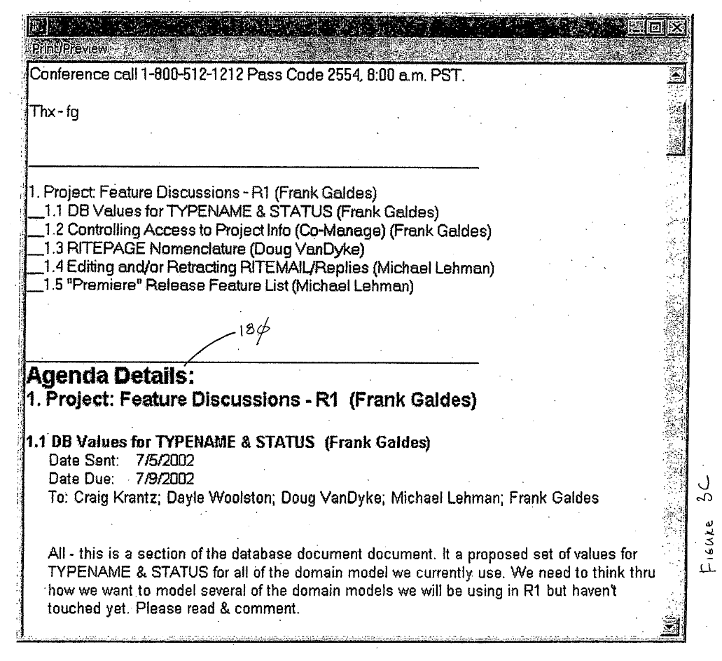

It is also contemplated to provide a set of options by which to enable a user to access, display, manage, or otherwise use data associated with selection of the Project tab 20. For this example embodiment, selected, example options are disposed as buttons in a panel above the list of projects, including:
Agenda 82—initiates the solution's agenda creation functionality (see FIG. 3A).
Finalize Agenda 84—initiates the finalize agenda functionality which enables the user to create and send the agenda.
View 86—as to the selected project, displays the selected discussion (e.g., preferably, the content of the selected discussion, including all messaging, is brought up in a window, enabling the user full access thereto).
Manage 88—enables a user to manage the selected project. Project management functionality includes, as examples, changing due date, closing a project, re-opening a project, and associating the project with one or more work processes.
Show 90—enables a user to filter the list of projects being displayed. This filtering mechanism supports various filters including as examples, but not limited to: “My Open Projects”, “My Closed Projects”, “All My Projects”, “My High Priority Projects”.

The options supported (as well as the implementation aspects thereof, e.g., status indicia) generally are either/both an implementation option and/or a configuration option. It is understood that these and/or other options may be supported without deviating from the principles of the invention.

Here, the Show button 90 is selected to filter for “My Open Projects”. Using this filter for the Projects tab 20 provides for display of data relating to all open projects for which the user is the owner. In this example embodiment, data as to such projects is displayed so that projects appear in a list in an upper panel of the screen shot. The list preferably includes various categories of data. Here, selected, example categories, as shown, include:
Project 68—project name or other denominator
Owner 70—name of project owner
Close Date 72—expected completion date of a project (e.g., preferably established by the owner at the initiation of the project, or as the owner updates same thereafter)
Priority 74—a priority associated with a project (e.g., preferably established by the owner at initiation of the project, or as the owner updates same thereafter, and preferably selected from a pre-determined universe of indicia so as to enhance filtering)
Location 76—a geographical location of a project (e.g., preferably established by the owner at initiation of the project, or as the owner updates same thereafter, and preferably selected from a pre-determined universe of indicia so as to enhance filtering)
Dept 78—a department responsible for a project (e.g., preferably established by the owner at initiation of the project, or as the owner updates same thereafter, and preferably selected from a pre-determined universe of indicia so as to enhance filtering)
Key 80—word (aka Keyword) or phase associated with a project (e.g., preferably established by the owner at initiation of the project, or as the owner updates same thereafter, and preferably selected from a pre-determined universe of indicia so as to enhance filtering)

The categories supported (as well as the implementation aspects thereof, e.g., indicia re Priority 74 and Key 80) generally are either/both an implementation option and/or a configuration option. It is understood that these and/or other categories may be supported without deviating from the principles of the invention.

It is also understood that the categories provided may vary based on the filter that a user selects via the Show button 90. It is understood that the scope of projects that may be displayed via the Projects tab 20 typically responds to (a) the individual and cumulative scope of the filters supported under the Show button 90, and (b) either/both any implementation option and/or configuration option which alone or together serve to restrict that scope of projects that are available at all via the Projects tab 20.

It is also understood that, if the projects available under the Projects tab 20 are co-extensive with the projects available under the Overview tab 22, one such view may suffice. As an example, the Overview view may enable display of data relating to all projects the user is working on or has worked on, and whether or not the user is the owner of the project. Similarly, the Project view may enable the display of the same data. Even so, motivation for supporting both such views may be provided by differences in user interfaces and facility (e.g., actual or perceived) associated with each view. That is, one view may make certain information more readily available (e.g., first screen) and/or more valuable to a particular use (e.g., layout of the data, such as in contrast to select other data).

In addition, motivation for plural views may be found in the context of licensing the solution (i.e., in linking the solution to revenue). This motivation is recognized to gain imperative when faced with the challenge of gaining penetration for the solution, specifically in the context of strained or otherwise tight budgets and/or when faced with “not invented here” syndrome. In such case, the solution with only one view supported may be licensable at a reduced rate (e.g., free). As an example, this reduced rate solution may be licensed by supporting only an Overview view, relegating the user to “read only” access to the solution's features and functionalities. Note that the Overview view provides options that enable a user to drill down into data, but not to manage a project, create an agenda or the like. In contrast, the solution may be licensed at a full rate by supporting the Projects view, with or without the Overview view, as the Projects view enables more powerful functionality relating to projects. Generally, the determination of the functionality per view, in any licensing program, comprises a business option and, particularly, solves the business of commercializing the solution.

As stated for FIG. 2A, it is contemplated to provide a set of options by which to enable a user to access, display, manage, or otherwise use data associated with selection of the Project tab 20. For this example embodiment, in addition to the options disposed as buttons in a panel above the list of projects, additional options preferably are provided for a selected project which enable (a) access to data relating to the project and (b) associating the project with work process. Here, two options directed to so enabling the user are disposed in a panel below the project list and are designated by Communication tab 100 and Ritepath tab 102.

In FIG. 2A, Communication tab 100 is selected. When this tab 100 is selected, it is contemplated to display data relating to the selected project. Here, displayed data includes data relating to (i) group members associated with the selected project (see description of FIG. 1B) and (ii) discussions of the project (see description of FIG. 1A).

FIG. 2B is a screen shot illustrating the example embodiment of FIG. 2A, showing solution data displayed upon selection of Ritepath tab 102. When this tab 102 is selected, it is contemplated to display data relating to work process, if any, associated with the selected project.

In an example embodiment, work processes preferably are represented as a set of tasks, each such task having one or more associated steps. Each step may itself have sub-steps and so on. It is also preferred to control the levels in the work processes such that some reasonable level of process separated from the task level captures a fundamental type, amount, portion or other element of work in the context of the project. It is contemplated that either/both tasks and/or steps may be designated with various attributes and/or may be associated with metadata (e.g., relating to a project or to the task/step). Example attributes include, as examples, that a task/step may be (a) either mandatory or optional and/or (b) part of a sequence of tasks/steps (i.e., is to be accomplished before another task/step and/or after another task/step. Preferably, attributes are designated when the work process is associated with the project. Moreover, preferably, an attribute may be re-designated during the pursuit of the project. Such re-designation may be variously controlled, such as to require sign off from a project owner, from a higher level official, from the work group (e.g., by majority assent or some other mechanism(s)), or some combination of the above, or otherwise. It is understood, however, that work processes may be established, in whole or in part, other than as stated above, without deviating from the principles of the invention.

In an example embodiment, work processes are defined and/or associated with projects by one or more user(s) of the solution. In this embodiment, such user(s) typically are members of a work group in the project and define work processes in pursuing the project. Accordingly, such user(s) preferably are enabled to revise the work processes during such pursuit (e.g., as indicated by the Edit button 118 in panel 104 in the screen shot of FIG. 2B). In another example embodiment, user(s) and/or group member(s) select work processes from predefined versions. Such predefined versions may or may not be customizable (e.g., in whole, in part or not at all) to the project. Here, the selection of processes preferably may be revised and the selected process preferably may be customized during the pursuit of a project (e.g., as indicated by the Edit button 118 in panel 104 in the screen shot of FIG. 2B). In other embodiments, work processes may be defined and associated to projects in either or both these ways, or otherwise, which approach generally is either/both an implementation option and/or a configuration option. Accordingly, it is understood that these and/or other approaches to work process definition and association may be supported, without deviating from the principles of the invention.

Process view panel 104 displays a high level view of an example work process named “Partner Lead Qualification Process”. This work process comprises three tasks, named: “Preliminary Analysis”, “Functional Area Buyoff” and “Exec Staff Review”. The “Functional Area Buyoff” task has displayed four steps: “Marketing Buy In”; “Product Management Buy In”; “Professional Services Buy In” and “Sales Buy In”. In this example, each task is represented by a folder to which the respective task name is associated. Moreover, each task's folder may be expanded (e.g., by user selection thereof via mouse click or otherwise) to show the step(s) thereof. In turn, each step is represented by a clipboard-like icon.

In process detail panel 106, with Overview tab 107 selected, steps of the process displayed in panel 104 may be reviewed for associated metadata. In an example embodiment, metadata may include, as examples, one or more of the following:
Status—the status describes the current state of the step. Status values preferably are established when the process is defined and/or associated with the project. Some example status indicia 108, as shown in panel 106, include: “Not Started”, “In Progress”, “Closed”, “Warning” and “Blocked”.
Description—preferably, a brief explanation of how to execute a step which information, here, is accessible by selecting the Description tab 110, as shown in panel 106.
Notes—notes regarding a step's current status, typically input by a user, which information is accessible, as an example, by selecting the Notes tab 112, as shown in panel 106.
Due Date—when a selected step is due.
Completed Date—when a step was actually completed
Help Information—information relating to the work process, such as, for example, how to complete a step. Help information can variously supported. Examples include: (i) providing an entry in a location provided within panel 106 (e.g., as accessed by an tab); (ii) attaching, as indicated by icon 122 in panel 104, a help file to a task/step (e.g., the file may be any type, including an HTML page and/or a file in any of the various MS Office formats) and/or (iii) referencing (e.g., via a link 120 in panel 104). a help file to a task/step. Help Information preferably is context sensitive and specific to the associated task/step.
Templates—templates are provided to assist or drive users in completion of tasks/steps. Templates preferably are specific to the project, to the work process and/or to the associated task/step. Templates can variously supported. Examples include: (i) providing an entry in a location provided within panel 106 (e.g., as accessed by an tab); (ii) attaching, as indicated by icon 124 in panel 104, a template file to a task/step (e.g., the file may be any type, including an HTML page and/or a file in any of the various MS Office formats) and/or (iii) referencing (e.g., via a link in panel 104). a Template to a task/step. Templates preferably may be designated as either mandatory or optional (e.g., if mandatory, the Template tends to drive the process and to enhance consistency, particularly in projects that are repeated over time).
Completed Documents—documents associated with execution of a task/step, including documents arising from using a template associated with such task/step Completing, following or otherwise abiding the such documents preferably can be either mandatory or optional. Completed documents preferably can be any file type, including various MS Office formats (E.g., MS Word or Excel).
Discussions—lists discussions within a project, the project being associated with the work process. Discussions preferably can be associated with multiple steps. Here, discussions are accessible by selecting Discussions tab 114, as shown in panel 106 (see description for FIG. 2C).
People—people associated with project, at least via a step. Here, data respecting people are accessible by selecting People tab 116, as shown in panel 106.

As to work process and its metadata, editing functions preferably are supported. In an example embodiment, a user accesses such functions by selecting Edit button 118 which selection opens an edit menu and brings up a work process editor. From the work process editor, the user may be variously enabled to edit the work process, e.g., to update the work process. Examples of updates that may be supported, include:
Adding, revising and/or removing notes
Adding, revising and/or removing documents
Associating and/or removing association of discussions with projects (see discussion that follows)
Adding, revising and/or removing tasks and/or steps, or otherwise changing the work process
Adding, revising and/or removing people

In the example embodiment shown in FIG. 2B, some metadata is displayed, while other such metadata is not. Such display may also be altered by the user, by providing that option, e.g., via selection of the Edit button 118. Generally, however, such display choice is either/both an implementation option and/or a configuration option.

Further to FIG. 2B, the “Sales Buy In” step is displayed. This step's status is “Warning”. This status is indicated both (a) by an exclamation point icon appearing in the step's icon of panel 104 and (b) by the selection of the “Warning” radio button in panel 106. It is understood that status of this type, and others, as well as icons, buttons and other indicia therefor, may be otherwise provided, without deviating from the principles of the invention.

Task status preferably is inherited from the step(s) it contains. As an example, if a step is blocked, the entire task is blocked. In FIG. 2B, an example of this inheritance concept is indicated by an exclamation point icon appearing in the folder icon for the task “Functional Buyoff”, the exclamation point indicating a “Warning” status for the task, which status is inherited from the “Warning” status of the “Sales Buy In” step.

Other steps in the example shown in panel 104 show various status. As examples, (a) the step “Marketing Buy In” is shown to be completed by a check mark icon appearing in the step's clipboard icon; (b) the step “Professional Services Buy In” is shown to be in progress by an arrow icon appearing in the step's clipboard icon; (c) the “Preliminary Analysis” task is shown to be completed by a check mark icon appearing in the task's folder icon; and (d) the “Exec Staff Review” task is not started, as shown by the absence of an icon appearing in its folder icon.

Step status is a parameter that the solution employs in notification(s), as is discussed elsewhere herein.

Also in panel 104 of FIG. 2B, the work process shows sequence attributes. In this example embodiment, the steps for the “Functional Area Buyoff” task show weak, if any, sequence. That sequence attribute is indicated by the status indicia and in the context provided by the step names: by that context, steps appear to be pursuable here in parallel which attributes are affirmed one step having “Warning” status being interposed between “Completed” steps and an “In Progress” step. Also in this example embodiment, the tasks for the “Partner Lead Qualification Process” process indicate a sequence for completion: “Preliminary Analysis”, then “Functional Area Buyoff” and then “Exec Staff Review”. This indication for tasks is shown via status indicia and in the context provided by the task names. The task sequence may also be shown by using selected numbers, markings, icons, or other indicia. It is understood that the solution may support sequence in various ways, if at all, and in doing so, sequence may be indicated more or less explicit/implicit (including the implementation aspects thereof, e.g., indicia), all of which generally is either/both an implementation option and/or a configuration option.

FIG. 2C is a screen shot illustrating the example embodiment of FIG. 2A, showing solution data displayed upon selection of Ritepath tab 102, together with the Discussions tab 114 of panel 106. When this tab 114 is so selected, it is contemplated to display data relating to discussions associated with the selected project. In this example embodiment, all of the discussions associated this project are listed in the panel 106, while those discussions associated specifically with the selected step of the work process are identified. Here, that identification is via a check mark placed in a column of boxes disposed adjacent to the list of discussions.

It is understood that the solution may support such presentation and identification in various ways, if at all, which generally is either/both an implementation option and/or a configuration option. As an example, selecting the discussions tab 114 may provide a list of only those discussions associated with the selected step.

It is also contemplated to enable one or more discussions to be associated with a step. As an example, a discussion may be associated with a step by a user placing a check in a box associated with the discussion. Alternatively, such association may be supported in the editing functions made available to a user upon selecting Edit button 118.

It is also contemplated that the solution enables controls on the association of discussions with projects. As examples, such controls may include: (a) controlling which projects may have discussions so associated (e.g., closed projects are restricted, and/or projects having certain location(s) are restricted), (b) controlling which discussions may be associated (e.g., discussions which are in progress and not blocked, or discussions which are due greater than some time in the future, or discussions with a due date selected time period); and/or (c) controlling which group member(s) may perform the association (e.g., owner of the project, higher level management or executives which are specific access users, and the like). It is understood that the solution may support such association process and/or controls thereon, or not, and that, if either are supported, such support may be provided in various ways, which generally is either/both an implementation option and/or a configuration option.

FIG. 2D is a screen shot illustrating another example embodiment of a solution as contemplated by the present invention. More specifically, FIG. 2D shows another example of work process. In this example embodiment, as with the previously described embodiment, work processes preferably are represented as a set of tasks, each such task having one or more associated steps. Indeed, the attributes, metadata and other characteristics of work processes set forth above is contemplated to apply to this embodiment. However, in this example embodiment, work process functionality is accessed by a user through a browser client.

In the left panel 140, the “Disclosure” work process is displayed which is associated with the folder “123456”. Here, the “Step 2” task is selected. Each step in “Step 2” is completed (i.e., as indicated by the check marks placed in the respective clipboard icons) and, as such, task “Step 2” inherits that indication of being completed (i.e., as indicated by the check mark in the folder icon thereof).

In the right panel 142, content of a selected step of a task is displayed. Here, the content is that of the selected step “Complete Summary”. The panel 142 may be implemented variously re the content to be displayed. Here, the displayed content includes, as an example:
A status of the task and the step: here, both are marked CLOSED.
A “Description” entry provides a brief summary of what should be done to complete the step.
A “Note” entry, here, describes the work completed in closing the step.
A completed document is provided, named “123456Summary.doc”. The document can be accessed by clicking the link.
Discussions are associated with the step, both discussions being having a CLOSED status. Both discussions can be accessed by clicking a respective link.

In this example embodiment, various buttons are displayed. Generally, these buttons correspond to similarly labeled buttons and tabs described already. In one example, an “Update” button is provided which enables a user to update the step, if and as necessary. This button preferably supports functionality as described previously for the Edit button 118 with reference to FIG. 2C.

FIG. 3A is a screen shot illustrating the example embodiment of FIG. 1A, showing solution data displayed upon selection of Projects tab 20 together with the Agenda button 82. When Projects tab 20 is selected, as previously described, projects relating to the user are displayed. More specifically, data is displayed that characterize, describe or otherwise give access to one or more of such projects.

When the Agenda button 82 is selected, the solution's agenda creation functionality is triggered.

That is, selection of the Agenda button puts the solution in a mode wherein a user is enabled to create an agenda by selecting various objects.

In an example of this functionality, a user selects a project and, for such selected project, identifies (i) members to be associated with the agenda and (ii) discussions to be included in the agenda. Preferably, A user preferably is enabled to select one or more projects for each agenda. Similarly, for each selected project, a user preferably is enabled to select one or more members and/or 25 discussions.

Such selection of objects may be variously providing in the solution. As an example, here, members and discussions are selected by the user placing a check in respective boxes 150 associated with each such member and/or discussion. It is understood that the selection may be otherwise provided, which generally is either/both an implementation option and/or a configuration option, without deviating from the principles of the invention.

FIG. 3B is a screen shot illustrating the example embodiment of FIG. 3A, showing solution data displayed upon selection of the Finalize Agenda button 84. When the Finalize Agenda button 84 is selected, it is contemplated to display an Agenda Editor screen 160. The Agenda Editor screen 160 is contemplated to provide functionality enabling a user to finalize an agenda, as initiated using the Agenda button 82. Finalizing an agenda preferably entails one or more of, among other things: organizing and/or revising the organization of the agenda; associating the agenda to a project; naming the agenda; applying a due date to the agenda; closing on the persons to be invited to review and/or work through the agenda items; apply other metadata to the agenda (e.g., comments, direction or otherwise); and sending the agenda out to the persons selected to receive it.

While the Agenda Editor screen 160 may be variously implemented, an example of such screen displays data and provides functionality, as follows:
Project 162—associates this agenda with a selected project (e.g., here, “Feature Discussions—R1”)
Subject 164—the subject of this agenda (for users accessing the solution via email, this entry typically provides the email subject)
Due Date 166—the date the agenda is due
To 168—list of people to whom the solution will send this agenda. The solution populates this list based on people selected as described with reference to FIG. 3A. Preferably, users can be added/removed from this list. Typically, the solution obtains these addresses by accesses the email or other address book of the user finalizing the agenda.
Introductory Comments 170—a text area that becomes a part of the message covering the agenda, which the user may or may not complete (e.g., to give additional information or direction to the recipients of the agenda).
Agenda Items 172—a list of agenda items comprising projects and associated discussions, these items being selected as described with reference to FIG. 3A. Typically, the solution numbers, outlines or otherwise organizes the items, including, as examples, (i) ordering the items by project and associated discussion(s) and/or (ii) identifying each item's owner by name. The list of agenda items becomes a part of the message send to those people listed in the To entry 168.

It is contemplated that the Project entry 162 may be selected by the user setting the agenda. More specifically, that user preferably is enabled to select such entry from among the Project(s) comprising the agenda, or otherwise. As an example, the user may select a project directed to the agendas themselves, e.g., a “Weekly Progress Meeting” project.

From this screen 160, the user preferably is enabled to send the agenda-bearing message, and/or preview the message. The user preferably is also enabled to cancel same. Such functionality is provided, here, via buttons 174 disposed at the top of the screen.

FIG. 3C is a screen shot illustrating the example embodiment of FIG. 3B, showing solution data displayed upon selection of the button 174 marked “Preview”. Specifically, this screen shot enables a user to preview the agenda-bearing message that is proposed to be finalized, e.g., to be sent to other users.

This screen shot also illustrates that, in providing for agendas, the solution creates a section, here labeled “Agenda Details”, that includes the discussions selected or otherwise associated with the agenda.

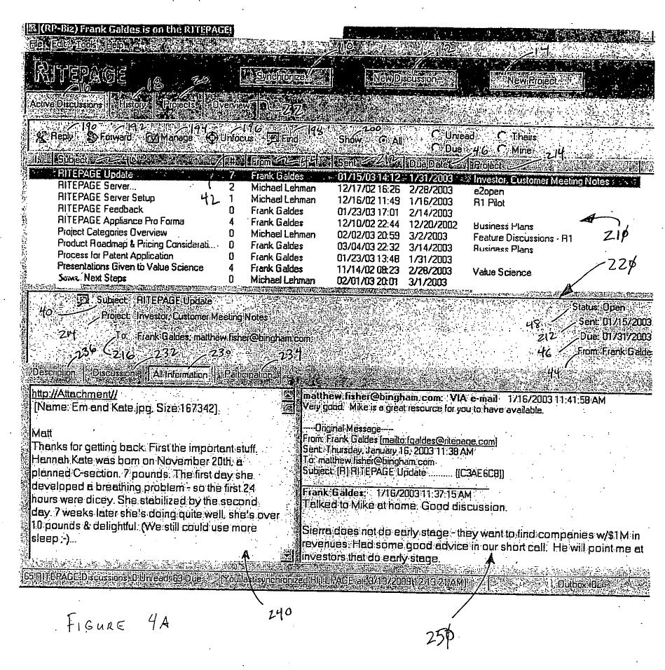

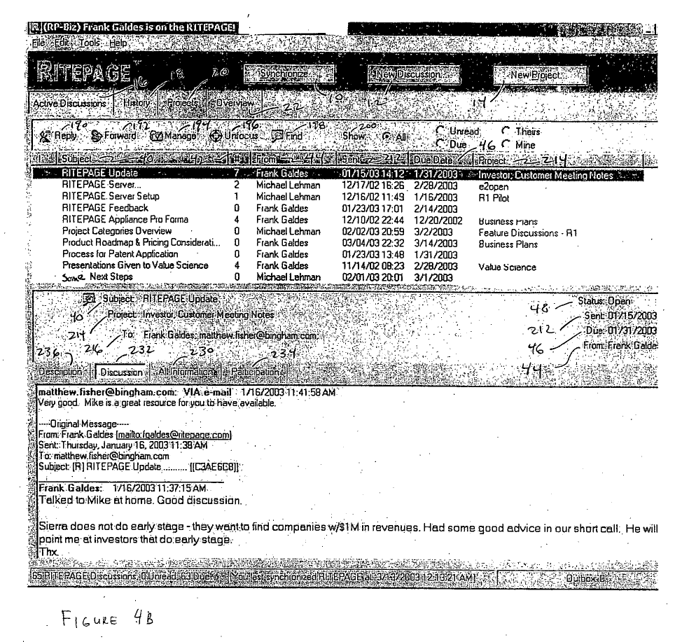

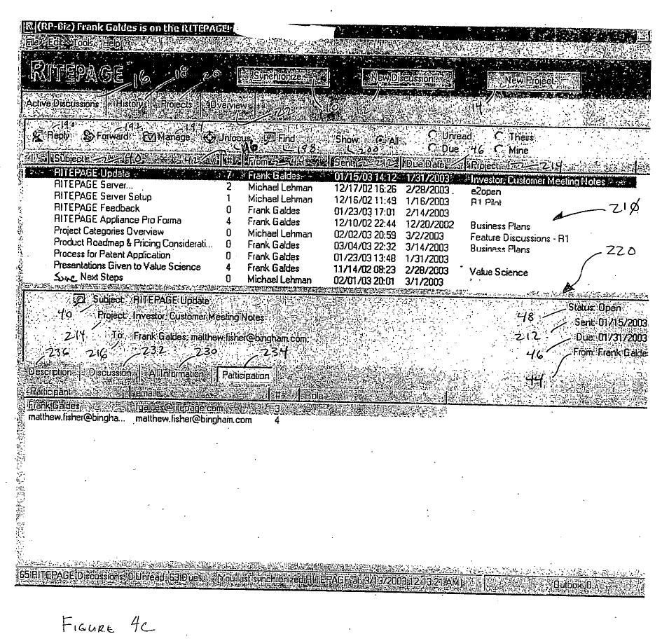

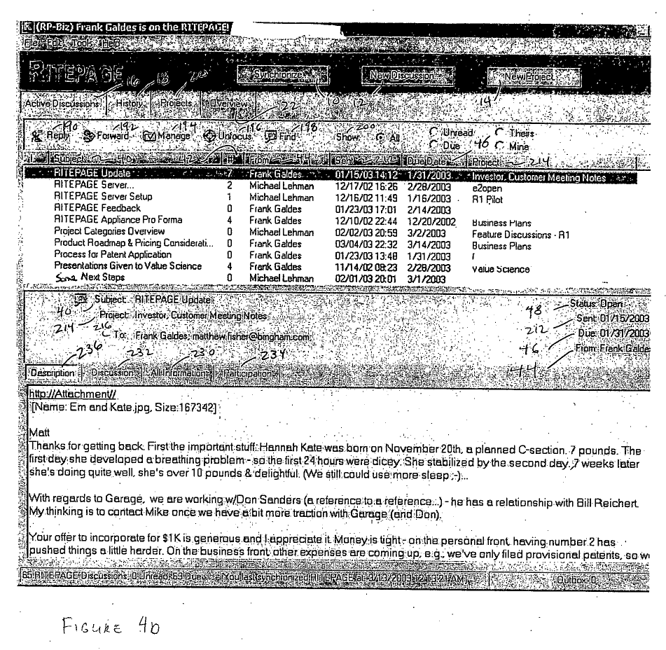

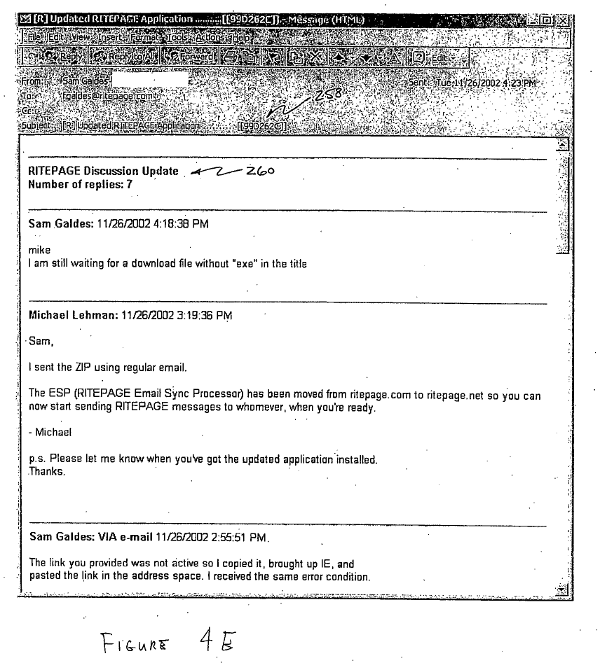

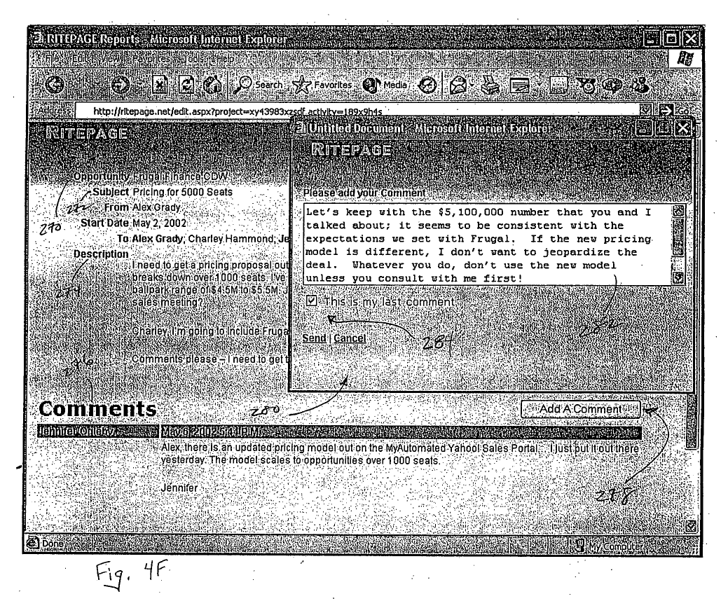

FIG. 4A is a screen shot illustrating the example embodiment of FIG. 1A, showing solution data displayed upon selection of Active Discussions tab 16. When this tab 16 is selected, it is contemplated to display discussions relating to the user. More specifically, it is contemplated to display data that characterize, describe or otherwise give access to one or more of such discussions.

In this example, the displayed discussions which are active (e.g., not “closed” as same is provided in the solution). It is contemplated that the criteria for displaying discussion may be otherwise provided (e.g., discussions may be restricted to those that the user owns), which criteria generally are either/both an implementation option and/or a configuration option. Note, however, that such criteria preferably are selected in light of the selections associated with other supported views, e.g., the view associated with the History tab 18. By coordinating views among related tabs, a user preferably is enabled to display, by using the provided views, their discussions in a structured manner, to enhance efficiency or otherwise to obtain advantage. As an example, the History view may be implemented to enable view of all discussions the user has ever been in any way involved with (e.g., even as a specific access user), while the Active Discussions view may be implemented to enable view of certain, current discussions.

It is also contemplated to provide a set of options by which to enable a user to access, display, manage, or otherwise use data associated with selection of Active Discussions tab 16. For this example embodiment, selected, example options are disposed as buttons above an upper panel 210 in which discussions are listed. These example options include:
Reply 190—enables a user to reply to a selected discussion.
Forward 192—enables a user to forward a selected discussion (as described below).
Manage 194—enables a user to manage a selected discussion. Discussion management functionality includes, as examples: changing due date, associating the discussion with one or more projects, and changing status.
Unfocus 196—invokes a filtering capability that enables a user to filter the list of discussions based on meta data, such as, owner, due date, project and status.
Find 198—starts a find function, e.g., a standard function based on key words.
Show 200—enables a user to filter the list of discussions being displayed. This filtering mechanism supports various filters including as examples, but not limited to: “All”, to show all discussions; “Unread”, to show discussions which have unread replies in them; “Due”, to show discussions that are due or late; “Theirs”, to show discussions owned by others (e.g., on which other people have asked the user to work); and “Mine”, to show discussions owned by the user and/or on which the user has asked other people to work.

The options supported (as well as the implementation aspects thereof) generally are either/both an implementation option and/or a configuration option. It is understood that these and/or other options may be supported without deviating from the principles of the invention.

The solution supports forwarding discussions via the Forward button 192. When discussions are forwarded, the solution preferably provides that the individual(s) selected to benefit from the forwarding is added to the distribution list. As such, the individual(s) will thereafter receive all updates to the discussion (e.g., subsequent messaging among all group members). Moreover, in forwarded, the solution tracks the event by creating a record in the database that flags the forwarding activity, tracks who forwarded what to whom, when and the like.

The solution preferably supports enabling and disabling forwarding functionality at the discussion and project level. Through support for this feature, users are enabled to create private (and/or more private) discussions and projects. This feature is useful in certain situations, such as where the conversations are very sensitive, e.g. merger negotiations.

Here, the Show button 200 is selected to filter for “All”. In this example embodiment, data as to such active discussions is thereby displayed, which data appears in a list in the upper panel 210 of the screen shot. The list preferably includes various categories of data. Here, selected, example categories, as shown, include Subject 40, # 42, From 44, and Due Date 46, each of these categories having been described with reference to FIG. 1A. In addition, example categories may also include, as shown: Sent 212 (e.g., the date and, preferably, time that the discussion was sent) and Project 214 (e.g., the project to which the discussion is associated). The categories supported (as well as the implementation aspects thereof, e.g., time with date) generally are either/both an implementation option and/or a configuration option. It is understood that these and/or other categories may be supported without deviating from the principles of the invention.

It is also understood that the categories provided may vary based on the filter that a user selects via the Show button 200. It is understood that the scope of discussions that may be displayed via the Active Discussions tab 16 typically responds to (a) the individual and cumulative scope of the filters supported under the Show button 200 and (b) either/both any implementation option and/or configuration option which alone or together serve to restrict that scope of discussions that are available at all via the Active Discussions tab 16.

In a lower panel 220 of the screen shot, solution data is displayed for a selected discussion. Such displayed solution data may be variously provided. Here, as an example, displayed data for the selected discussion includes data from the following categories, as previously described: Subject 40 (i.e., of “RITEPAGE Update”); Project 214; Status 48; Sent 212; Due Date 46; and From 44. In addition, example categories may also include, as shown, “To” 216 (e.g., the list of all group members associated with the discussion).

As stated above, it is contemplated to provide a set of options by which to enable a user to access, display, manage, or otherwise use data associated with selection of the Active Discussions tab 16. For this example embodiment, in addition to the options disposed as buttons 190-200, additional options preferably are provided which enable access to data relating to the discussion. Here, four example options are provided, as follows: (i) All Information tab 230, (ii) Discussion tab 232; (iii) Participation tab 234; and (iv) Description tab 236.

In FIG. 4A, the All Information tab 230 is selected. When this tab 230 is selected, it is contemplated to display selected information relating to the selected discussion. Here, displayed information includes: (i) in a left panel 240, the original message which initiated the discussion and (ii) in a right panel 250, replies to such original message, each of which replies is clearly delineated (e.g., by a line between each such reply) and attributed. As to attribution, each reply is pre-pended with the name of the user who sent the reply, as well as a date/time stamp respecting the sending. In addition, each reply preferably is marked to show the channel by which it was sent (e.g., replies from email users are identified as “VIA email”, while replies from within the solution itself preferably bear no mark). It is understood that each reply may be variously attributed, without departing from the principles of the invention.

Replies received from email users preferably are automatically associated with the discussion and associated project. All replies are tracked separately in the database. The solution supports filtering based on specific user.

FIG. 4B is a screen shot illustrating the example embodiment of FIG. 4A, showing solution data displayed upon selection of the Discussion tab 232 of panel 220. When this tab 232 is selected, it is contemplated to display selected information relating to the selected discussion. Here, displayed information includes all replies, from all people, in the selected discussion. Preferably, these replies are displayed as described previously. However, the replies may be otherwise displayed, without deviating from the scope of the invention.

FIG. 4C is a screen shot illustrating the example embodiment of FIG. 4A, showing solution data displayed upon selection of the Participation tab 234 of panel 220. When this tab 234 is selected, it is contemplated to display selected information relating to the selected discussion. Here, displayed information identifies all of the participants (e.g., by name and email address/other contact information) who are associated with the discussion. Other information about participants may also be displayed (e.g., how many replies they have added to the discussion), without departing from the principles of the invention.

FIG. 4D is a screen shot illustrating the example embodiment of FIG. 4A, showing solution data displayed upon selection of the Description tab 236 of panel 220. When this tab 236 is selected, it is contemplated to display selected information relating to the selected discussion. Here, displayed information includes the original message which initiated the discussion, which message typically was sent out to users.

FIG. 4E is a screen shot illustrating an example embodiment of a solution as contemplated by the present invention. In this screen shot, the solution is shown working in coordination with a standard email client (e.g., an off-the-shelf, commercial email client, such as Eudora). In particular, solution data respecting a particular discussion is shown, by way of example, rendered in such email client (cf., this data rendering to the data rendering inside the solution as set forth in panel 250 of FIG. 4A).

In coordinating with email clients, the solution may serve various data to the user, presented in various ways. Here, as an example, the served data includes: (i) in the email's subject line, the name of the discussion to which the email relates (together with a reference number 258 that the solution uses to uniquely identify the email, the discussion or otherwise, as discussed below), (ii) the name of the group member that sent the message in the discussion which caused the solution to send the email to the recipient (and, generally, to all other participants in the discussion) and (iii) the message thread of the discussion.

Generally, the solution supports interoperation with standard email. More generally, the solution preferably enables users to exploit the solution using a thick client (e.g., local solution functionality and/or a synchronized portion of the solution's database as is relevant to the user's access to the solution), any web client directed to link into the solution's server system, any off-the-shelf email clients communicating with the solution's server system, or any other channel which similarly is supported by the solution's server system. To do so, the solution's server system performs various tasks, including: interpreting a message received via any such channel; associating the message with the appropriate discussion; updating the solution database; and creating and sending update email messages to all implicated users.

In sending email to email clients, the solution preferably encodes a unique identifier into the email which identifier enables the solution to track communication with each user via their email clients. The unique identifiers may be variously implemented and variously encoded, without deviating from the principles of the invention. An example is the reference number 258 described above.

In operation, the solution tracks all outstanding email messages. When a message is received, the solution seeks to match, via the unique identifier, the received message with the messages it has sent out. In doing so, the solution preferably verifies that the user sending the message is authorized, that the discussion to which the email is associated continues to be accepting replies and that the communication is otherwise valid. Moreover, the solution parses the email to isolate content that the user has added. The solution adds the new content to the appropriate discussion and otherwise updates the solution's database. After updating the database, the solution publishes a consolidated message (i.e., organizes and formats all replies received since the previous publication) to all implicated users, via the various supported channels for each user, as appropriate.

The solution supports extending existing third party email clients to support solution functionality, including creating, sending and managing discussions and projects. The solution also supports integrating thin client browser based solution functionality into third party email clients.

Here, as shown in FIG. 4E, the message from the group member that triggered the email is presented at the top of the thread, with the thread bearing a header 260 which indicates that the email is an update from the solution (i.e., “RITEPAGE Discussion Update”). The header is effected as a template which includes selected metadata. Here, the metadata provided is the number of replies in the thread that follows It is understood that the form of the template (header, footer, or otherwise) and the metadata provided (e.g., the project name, the discussion name, the due date, etc.) are either/both an implementation option and/or a configuration option, and may be provided in various ways without deviating from the principles of the invention.

The message thread may be variously presented. Here, each message is clearly delineated (e.g., by a line between each such reply) and attributed. As to attribution, each reply is pre-pended with the name of the user who sent the reply, with a date/time stamp respecting the sending, and with a marking to show the channel by which it was sent (see discussion above in reference to FIG. 4A). It is understood that each such reply may be variously attributed, without departing from the principles of the invention.

In this example, two replies are from “Sam Galdes”. The later reply was made using the application. The earlier reply was made via e-mail. Users can reply to the same discussion using email or any application that provides the solution (e.g., thick or thin client).

FIG. 4F is a screen shot illustrating an example embodiment of a solution as contemplated by the present invention. In this screen shot, the solution is shown working in coordination with a standard browser client (e.g., an off-the-shelf, commercial email client, such as Microsoft's Internet Explorer). In particular, solution data respecting a particular discussion is shown, by way of example, rendered in such browser client (cf., this data rendering to the data rendering inside the solution as set forth in panel 250 of FIG. 4A).

In coordinating with browser clients, the solution may serve various data to the user, presented in various ways. Here, as an example, the served data includes: (i) in an opportunity entry 270, the name of the project to which relates the data being rendered; (ii) in a subject entry 272, the name of the discussion to which relates the data being rendered; (iii) in a description entry 274, a description of the discussion being pursued; and (iv) in a comments entry 276, the message thread of the discussion. In coordinating with the solution, the browser is enabled to provide functionality relevant to the solution. As an example, in this FIG. 4F, the browser supports a submit button 278, labeled “Add A Comment”. Here, the user has selected this button 278, which results in display of a box 280 comprising (i) a text area 282 labeled “Please add your Comment” and (ii) a check box 284 labeled “This is my last comment”.

This “last comment” feature enables a user to indicate they have completed their communication on this discussion. The solution tracks this information from this and other users, as meta-data that is associated with the discussion. As well, the solution preferably responds to the information, so tracks, so as to provide responsive notification, e.g. the solution may send a notification message to the project/discussion owner when a predetermined, threshold percentage of the group members have indicated they have no more comments and, as such, are effectively awaiting a decision.

It is understood that this “last comment” feature is not limited to browsers. It is also understood that this feature may be variously supported (e.g., via selection of thresholds, re discussions/projects to which it applies or doesn't apply, etc.), in that this feature generally is either/both an implementation option and/or a configuration option and, as such, may be provided in various ways without deviating from the principles of the invention.

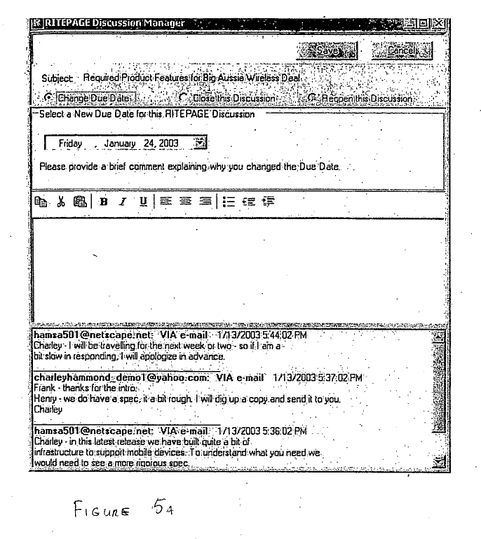

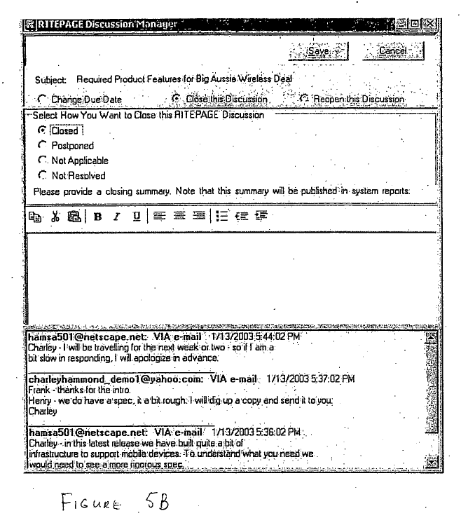

FIG. 5A is a screen displayed when the user selects the Manage button 194 (in FIG. 4A). This screen enables a user to manage the selected discussion. In a typical implementation, such management is enabled provided the user owns the discussion. From this screen, for example, the user can change the due date. In doing so, the solution preferably supports a mechanism for explaining to other users reason(s) for the due date change. Preferably, all due date changes are tracked by the solution and propagated to all users associated with this discussion.

FIG. 5B is a screen displayed when the user selects the Close this Discussion button (in FIG. 5A). From this screen, the user is enabled to close the selected discussion. When a discussion is closed, the user selects a discussion status. Preferably, as is shown here, the solution provides predetermined status values for selection by the user, (e.g. Closed, Postponed, Not Applicable and Not Resolved).

The solution preferably provides a mechanism for documenting final notes to be associated with the closed discussion.

Closed discussions are recorded by the solution and propagated to all users associated with the discussion. Preferably, the solution is implemented to enable the user to control whether notifications a sent when a discussion is closed. While this functionality is not depicted in FIG. 5B, it is recognized that the functionality may be supported as an implementation option or a configuration option.

Once a discussion is closed, it is no longer considered an active discussion. In such case, the solution preferably does not prevent a user from responding, but rather indicates to the user that the response is not being received as a timely response. In an example embodiment, if a user attempts to reply to a closed discussion, the solution will:
Send a message to the discussion owner informing them that a participant sent a message to a closed discussion.
Send a message to the sender of the reply indicating that the discussion is closed and that their reply is not acceptable.

As an implementation or configuration option, these messages may be sent via various channel(s).

The solution preferably is implemented to enable an owner of a discussion to re-open a closed discussion, when necessary. All re-open actions are recorded by the solution. FIG. 6A is the screen displayed when the user selects the New Project button 14. This screen enables users to create new projects. From this screen a user can specify the project name, due date and text description.

FIG. 6B is an alternative implementation of functionality associated with creating a new project. Here, the user is enabled to configure the functionality displayed by this screen.

This implementation provides, among other things, the following functionality:
“This is private do not publish in the report system” check box—This feature enables a user to control the visibility of the project to those people generating reports under the solution. Here, the feature, as shown, is binary: people can generate reports either with the implicated data or not. However, it is understood that the feature can be otherwise provided (e.g., to support a permission structure, applied to people individually, by role or otherwise), without deviating from the principles of the invention, and that the feature is generally provided as an implementation and/or configuration option.
RITEPATH entry—This enables the user to associate the project with work process, as previously described.
Scope, Type, and Track entries—These are user-definable attributes that a user is enabled to associate with a project. Here, the names are examples; the user is able to define the name of each entry, as well as legal values for the entry.

In an example embodiment, the solution may be designed to provide for creation of projects and discussions via a shortened process. As an example, using the process creation entries of FIG. 6B, the user can create both a project and an entry at the same time, by: (i) entering a project name in the Project entry; (ii) entering a description of the project in the Description entry; (iii) identifying members to the project in the To entry; and (iv) selecting the OK button. Here, the solution then creates a project and a discussion, wherein both bear the name entered in the Project entry, both have the description entered in the Description entry, and both have participants comprising the persons entered in the To entry. If other information is entered for the project, the discussion would also be populated with such information (e.g., Due Date becomes the discussion due date).

It is understood that this functionality may be variously implemented, without deviating from the principles of the invention (e.g., the discussion is automatically created, or not, based upon the entry of check mark in a check box) Generally, this functionality is either/both an implementation option and/or a configuration option.

FIG. 7 is the screen displayed when the user selects the New Discussion button 12. This screen enables users to create new discussions and may be variously realized. From this screen, a user typically is enabled to perform one or more tasks associated with creating a discussion, including as examples:
Project entry—associate the discussion to one or more projects
Subject entry—assign a name to the discussion
Due Date entry—assign a due date to the discussion
To entry—list participants to be invited to or otherwise receive this discussion. The Select button enables a user to access various address books, including, as examples any associated with email application(s) available to the user and/or any solution-dedicated address book.
“Do not send via email” check box—restrict the email communication channel as to this discussion. When this option is selected, users can only access this discussion using channels other than email.
“Do not allow this discussion to be forwarded in RITEPAGE” check box—control whether recipients are allowed to forward the message to other users. When this option is selected in combination with the “Do not send via email” option, the owner has substantial control over who can see this message and how.

In both the latter two functionalities, the functionalities are described as binary: email is sent or not and forwarding is allowed or not. It is understood that either/both such functionalities may otherwise provided (e.g., to support a permission structure, applied to people individually, by role or otherwise, extending to channels beyond email alone, etc.), without deviating from the principles of the invention. It is also further understood that these two functionalities generally are either/both an implementation option and/or a configuration option.

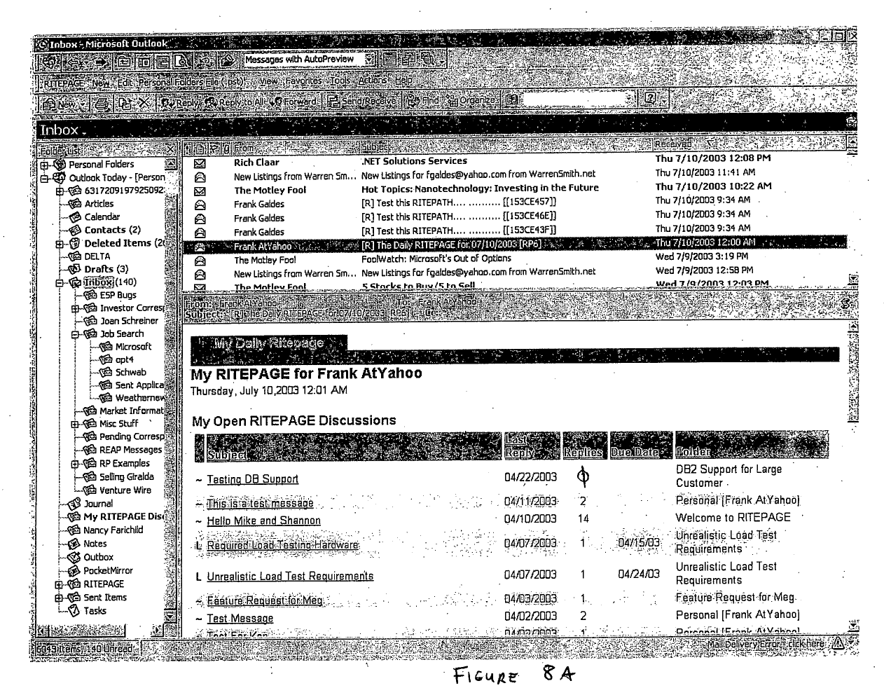

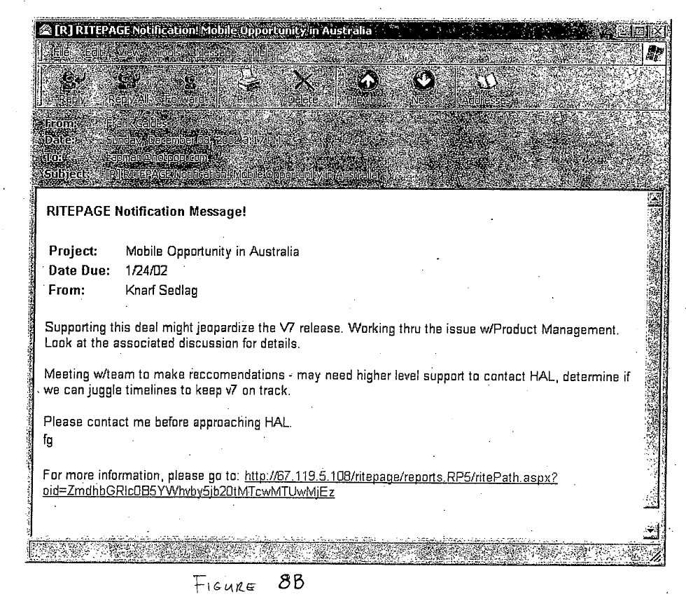

The solution preferably supports sending regular email —based notifications to users. FIG. 8A depicts an example notification email message. Notifications preferably are sent at a user-specified interval, e.g. daily, weekly, etc. Here, the depicted notification includes a list of discussions the user is currently working on.

The information included in a notification may be variously selected and presented. In the example, the information includes:
Subject—the subject associated with the discussion
Last Reply—the last date/time someone replied in the discussion
Replies—number of times the user receiving the notification message has replied to this discussion
Due Date—when the discussion is due to be completed
Folder—the project with which the discussion is associated

The notification contains discussions that the user has started, as well as discussions other users have asked them to work on.

Selecting any discussion by its subject entry launches the solution in a browser. The user preferably is enabled, via such browsers, to fully access the solution, e.g. to reply or manage the selected discussion.

FIG. 8B depicts a notification sent to a user when a specific condition is met. Such specific conditions may include, e.g., a step is blocked, a discussion in a specific project is open past the specified due date, a project is late, etc.

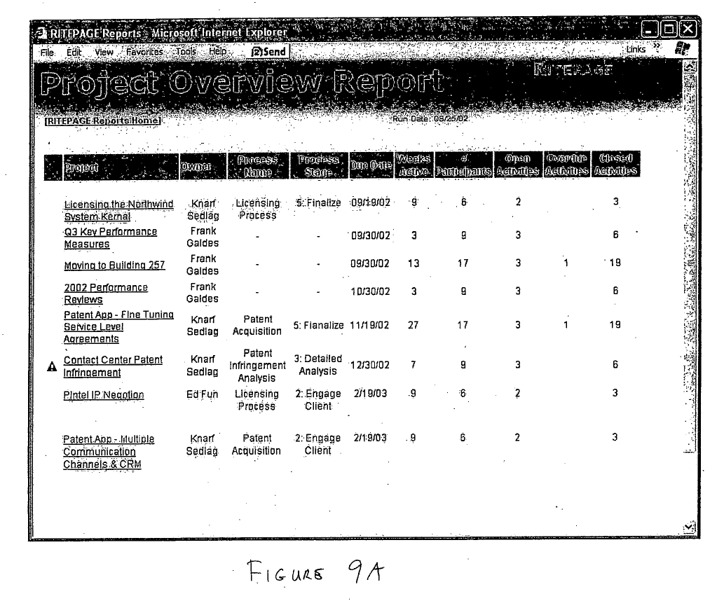

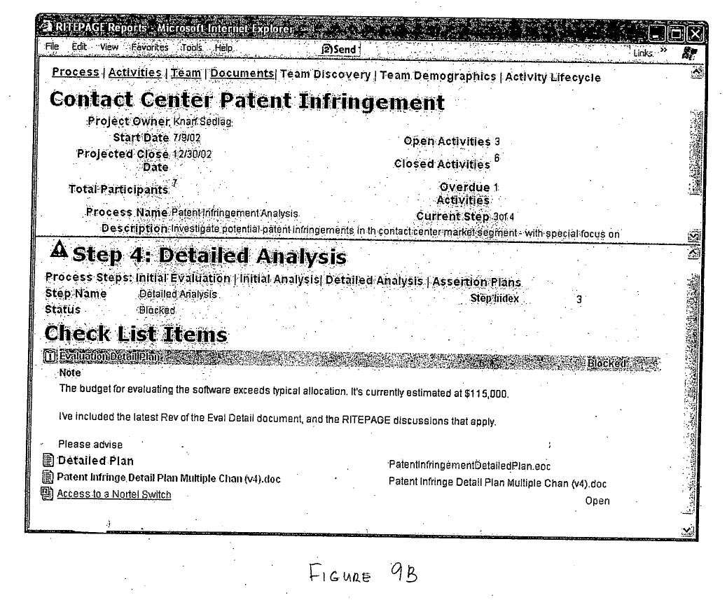

Here, a link is embedded in the notification message. When the user clicks this link, the user is taken to the object of the link. In the even the notification is tied to a specific condition, the link typically will take the user to the object(s) that is associated with that condition, e.g., to the blocked step, the late discussion or the late project (see description below with reference to FIG. 9B).

FIG. 9A depicts an example project report that might be available to a manager or executive using the solution. In this report, the following is visible:
Project—the project name
Owner—the person who owns the project
Process Name—the name of the work process associated with the project
Process Stage—the step currently being worked on
Due Date—the project due date
Weeks Active—the number of weeks the group has been working on the project
Participants—the number of people working on the project
Open Activities—the number of open discussions associated with this project
Overdue Activities—the number of open discussions which are late
Closed Activities—the number of discussions which have been closed on this project

FIG. 9B depicts an example process report for a blocked project. This screen depicts project information and the process step that is blocked. From this report, a user is enabled to view the discussion where the problem is being discussed. For example, in this case, when the user clicks the “Access to a Nortel Switch” link, the solution will display the details for this discussion. From the discussion details, a user is enabled to view, e.g., the content and direction of the discussion, who has contributed (and who has not) and similar information.

In the solution, reports preferably are connected to real time data. As participants reply to discussions, the replies are added to the database and made available to the reporting server.

FIG. 10 depicts an example deployment configuration for the solution. It is understood that the solution may have various deployment configurations, without departing from the principles of the invention. It is also understood that not all components of this example deployment configuration are necessary for any particular implementation of the solution and, as well, other technologies may be used to provide the same or similar functionality.

In a deployment configuration, one or more of the following components, as illustrated in the example configuration, typically could be included:
Admin Web Service—administration services for controlling access to solution application services and web servers. When a solution client attempts to establish a session to exchange information, the application first communicates to the Admin Web Service—which authenticates the user and then identifies which service the user should access to service their request.
Solution Synchronization Web Service—provides synchronization services to all clients. This includes desktop clients as well as other solution servers which are sharing data.
Remote Solution Server—if multiple solution servers are used, the servers synchronize databases using the Solution Synchronization Web Service. This deployment option is one way the solution scales.

Email Synchronization Process Server—provides the integration to email by retrieving messages, e.g., via POP3/IMAP, and sending them via, e.g., SMTP.
Report Server—provides solution reports of application data stored in the solution Data Base—reports are available via the user's web browser.
Solution App Server—the server which provides solution functionality for browser based users.
Attachment Services—manages the attachments sent via the solution and as attachments in email. Solution clients (desktop and Email Synchronization Process) write documents to the FTP Server. Desktop and email clients access the project documents via the HTTP document server. HTTP document server is visible outside of the firewall for email users to access attachments. Both the FTP and HTTP document server share the folder where documents are stored.
Solution External Proxy. Provides Internet access to the solution functionality and reports.
Solution Sync DB Server—the synchronization database, i.e., synchronization data is stored in this database. This synchronization database is used to synchronize multiple databases including desktop clients and other solution databases.
Solution DB Server—the application database that contains all communication information.
Notification Server—generates notifications, e.g., based on user specifications; notifications typically are sent out via email and the Email Synchronization Server.
Solution running in the browser—thin client version of the application.
Directory Integration—integrates to employee/user directories, imports organization information into the database. Solution uses existing standards, e.g. LDAP, Active Directory, Exchange, etc.
Integration Server(s)—servers that integrate to other enterprise applications. This enables third parties to integrate the solution.

In another example embodiment, it is contemplated to consider the strengths and weaknesses of email, toward arriving at a solution, in accordance with the principles of the invention. Email is a generally ubiquitous standard for asynchronous communications. It is used in nearly all, if not all, substantial organizations in the world. Its widespread use has permeated every aspect of doing business, from organizing meetings to distributing sales contracts. Email has a rich feature set, it has an intuitive interface, it is convenient to access, and it automatically documents every transaction. The server that distributes the corporate email holds a plethora of information in its bowels. So how do we get at that information? How do we add structure to email and use it to help us do our business more effectively?

Among other things, in this example embodiment, it is contemplated to reformat the standard email interface. One reason for doing this is to add a notion of accountability.

Let's take a look at some example modifications:

Invitation to Participate—Send a read-only version of email with a prompt that asks the recipient to accept or reject the assigned content before it is actionable. This adds the concept of explicit participation. With explicit participation, the solution can assign tasks, monitor acceptance, monitor rejection, and see which assignments have and haven't been acknowledged.

Project Name Field—By proactively assigning a project folder to an email (instead of backing into one later in an attempt to clear out a cluttered inbox), a container is placed around the content that can be used by the organization. This will help group associated tasks, it will facilitate reporting, and it sets a piece of architectural groundwork in place on which can be built the concept of projects.

Due Date Field—The due date field adds a sense of urgency and expected closure. Tasks run off of deadlines. Deadlines preferably are explicit and communicated. Due dates set expectations and, when paired with an invitation, allow an individual member to sign off for responsibility on their own accord.

Structured Activities—Many if not most of the activities that work teams do via email engender more structure than email's free form text enables. Examples include: voting, distributing agendas, taking meeting minutes, assigning tasks, resolving issues, and reviewing documents. Adding tools into email that facilitate these structured communications streamline the work that the teams may do and make them more efficient and successful.

Follow Up—The system reviews the work that is being done (or isn't being done) and acts automatically to send notifications. It is a mechanism (e.g., early warning) to ensure that expectations are being met and that the proper people are being informed.

These changes and others contemplated by this example embodiment create a framework for accountability in the system. It makes the work clear. Once the work is clear, it enhances the acceptability of making people accountable. Email without these concepts tends to be too vague in the context of the work. This tends to be particularly so if email is copied to multiple people (e.g., it tends to become unclear as to who owns the follow up).

Some characteristics of this example embodiment include:
It puts execution first
It is flexible with how it handles people, activities, and organization
It addresses the needs of the constituents

Once you have an accountable email system with defined due dates, explicit participation, and no ambiguity, you have an environment for discovering who is on your team and for discovering the real issues on the project. The mechanics allow you to see the real work that is being done. As you start getting the right people involved they start ferreting out the real issues and, hopefully, the right answers. Once you understand the people and the issues, the organization that you need for the project becomes apparent, as well. Since you know who is involved and the actual volume of activity, you can put organization around the activities and begin to structure the project.

This notion of action leading to discovery is important because projects on distributed teams tend to have a life of their own. For example, when a sales lead comes in you don't immediately know if it's a big lead or not. Even so, a sales lead tends to grow organically as it matures and develops. The sales rep that initiates a project internally usually doesn't know who all to invite to the thread. Tasks float around the organization as emails are forwarded and replied to, while people may joining and depart the project and/or any of its discussions. This tends to be how projects develop in the real world, and this is how distributed teams work.

Also in this context, at the outset, the sales force doesn't know if it should put a lot of process around any lead. Process streamlines activity, but putting a process in place requires a lot of overhead and may not advance the work on the lead.

As such, this example embodiment preferably supports discovery of resources by leveraging the intelligence of the organization, no matter how that intelligence is brought to bear. The embodiment allows members to invite other people into an activity to answer difficult questions. This way productivity happens where rigid structure could have prevented it.

The example embodiment recognizes that there tend to be various salient pieces to the dynamic of a project. Three of these are the people, the activities, and the organizational structure. An application that is going to provide collaboration for distributed teams preferably is flexible with how it handles these pieces, e.g., including the above three.

In this example embodiment, it is contemplated to manage a team by introducing accountability, process, and timeliness and while maintaining a flexible system with open communication.

People—A way to remain flexible with people is to start with basics, e.g., be productive with a minimum amount of information about the team members. At first, the system knows is the person's email address. This allows the system to discover resources as people participate or are included on the thread. Once it knows who the players are on the team, more definition can be added. At the beginning, however, it is preferable to minimize (if not remove) barriers to entry.

Activities—In order to insure that work is getting done, it is preferred to monitor the timeliness and accountability of the tasks. Again, a focus on the basics is contemplated —who has signed up (email addresses), what have they signed up for, and when is it due.

Organizational Structure—Organizational structure preferably evolves with the project. Putting structure in place tends to require overhead. At the beginning of a project, it isn't always obvious how much attention should be put into the details. In many cases, it tends to be more efficient to wait until the issues become obvious. Structure can be added later, after the project has grown organically.

Being flexible with people, activities, and organizational structure follows directly on the concept of “put execution first.” Before process is put in place, start doing the work. As the work progresses, the work can be reviewed so as to determine if it is prudent to put process in place and, if so, what process.

The example embodiment addresses the needs of the users, e.g., an individual contributor, a manager of contributor or a project, and an executive overseeing projects or managers (i.e., one who is responsible at an enterprise level). As an example, to create a project view, e.g., for a contributor or a manager, the tools preferably support viewing selected, a subset or all activities associated with the project (i.e., a project may be generally characterized by its activities). As another example, to create an enterprise view, e.g., for an executive, the tools preferably support viewing all, a subset or selected projects of an enterprise (i.e., an enterprise may be generally characterized by its projects). This example embodiment recognizes, as one principle, that if every activity in a project is successfully completed (and the tasks therein are well defined), the project is positioned to be successful and that, if the projects of an enterprise are successfully completed, the enterprise is positioned to be a success.

Contributor—The example embodiment preferably enables individuals to interact with other team members via simple, structured communications. The interactions preferably are crisp and well defined. They also are preferred to be time-based, flexible, and have a notion of accountability.

In this example embodiment, at its foundation, is the contributor. When the tool starts collecting data, the data is preferred to be real data from contributors; i.e., data associated with actions of people who have specific expertise that is being contributed.

A way to find out real project activity is by walking around and looking over the shoulders of the individual contributors and reviewing their work. Is the team playing PacMan or are they coding? Is the team raising questions that aren't getting answered? In sales initiatives are they asking questions on how to open a deal or how to close a deal? Or, maybe, has the deal already been lost and it just hasn't been acknowledged? By observing real data you can get real answers.

When a team is co-located it is easy to get this real data. When the team is dispersed and you don't know all the players on the team, you benefit from a tool that provides this level of accountability to monitor team behavior. With the right data, you can spot trends and see things before they happen. You can see if your project is going south, or if your partners aren't carrying their weight.

Project Manager—The project manager, as contemplated, bundles the activities, and enables reports on them. Since the example embodiment started with structure and accountability at the lowest level, the embodiment is designed from the ground up for collecting and aggregating data. With accurate base level data, the project manager can set up early warning mechanisms that enable trend spotting. It is also enabled to create a method for monitoring and organizing team activities. This could be a way of organizing related activities into project folders, or organizing activities according to project milestones. With a concept of milestones, the project manager can drive deadlines and match milestones to real activity. The project manager can schedule meetings and send out agendas that are based on activities authored by the constituents themselves. These meetings and agendas preferably are automated by the system. An online agenda that is distributed before a meeting allows participants to see the project status in advance; that way, there are no surprises. The example embodiment can also account for meeting minutes by posting them directly into the system and attaching them to the milestone with which they are related.

Executive—At the highest level, concise, demonstrable metrics are available to executives so that executives can monitor the health and progress of the entire enterprise.

Metrics are used to measure progress. These metrics generally are straightforward so that everyone can understand them and measure activity against them. Sales uses the sales pipeline. Engineering uses ship dates and bug counts. Consulting uses headcounts and utilization percentages. Marketing uses number of leads passed to sales.

A beneficial aspect of such metrics is that they are obvious and easy to measure. A problem with such metrics is that they tend to be snapshots and they don't allow you to troubleshoot what is working or not working. They are also one dimensional in that they don't easily measure cross corporate activity.

It is desirable to raise metrics to a new level in order to drive the work done by complex work teams. This example embodiment preferably is implemented to provide cross project metrics over extended periods for measuring and comparison. These metrics preferably are made available by enterprise wide reporting based on user generated activity. Ultimately, measured are the very basics of the project: who is working, what they are doing, how much they are doing, and what is the status of the tasks they are working on.

Some of the technical characteristics of this example embodiment include the following:

Always available—It has a thick client to do the heavy work. It has a thin client to enable messaging and quick look reporting. Problems come to you; you aren't required to go seek out problems. It isn't necessary to configure the tool to go through firewalls; it knows how to do this by itself. The application is network savvy; it knows how to find people and resources. If you're on the net, it gets as much information as possible. It acts intelligently on your behalf to do your work for you, just like email.

Automatic synchronization—Automatic synchronization means that the system acts intelligently on your behalf to pull in information around the system to fill in the gaps on your view of the world. An example of this would be that, if a new manager starts on a project, she is able to pull a complete view of the project off of the machines of the other participants on the system. This also works to replace lost data or in situations when hardware malfunctions.

Uses existing tools—Businesses tend to have a significant investment in Microsoft and Lotus applications. The solution preferably leverages these applications, e.g., because so many people are using them. It preferably also enables leveraging of existing infrastructure, e.g., so that, adopters may but are not mandated to obtain another knowledge base or publication server in addition to the ones they already have. The system preferably enables straightforward integration to existing systems. Using existing tools generally simplifies the work.

Accordingly, the above comprise the general attributes of an example embodiment in accordance with the invention.

In another example embodiment accordingly to the invention, tools, methodologies, systems and other solutions contemplate implementation of a Project Manager (sometimes referred to herein as “PM”) and the Enterprise Manager (sometimes referred to herein as “EM”) (these two managers are sometimes referred to herein collectively or individually as “Managers”).

The Managers preferably are directed to organizing and reporting on progress in projects. Preferably, in this example embodiment, these Managers are not directed to provide for or otherwise handle communication among group members or otherwise.

The Managers preferably are related. As examples, the relationship may be characterized by the following:
Reports created in Project Manager may feed the Enterprise Manager and the Enterprise Manager may request reports from Project Manager.
Both preferably use similar organizational tools.
Both preferably have similar administration tools.

The Enterprise Manager preferably focuses on accessing reports and data. These reports and data may be variously provided, including through the Project Manager and/or through the Enterprise Manager itself. In the latter case, the reports and data preferably are created by administrative tools directed to such creation.

The following description begins by describing concepts that preferably are common to both Project Manager and Enterprise Manager and, then, discusses each Manager in more detail. The context for this description is the various functionalities, purposes and ends to which users may use a solution in accordance with the invention. Some examples of these functionalities, purposes and ends include:
Conceptualizing a product
Developing a product
Developing a business plan
Developing marketing materials
Engaging early adopters of a product
Raising funding
Interfacing product development and beta customers of a product
Interfacing professional services and customers
Managing communication between account execs and the rest of an organization, as well as with channel partners
   Additional examples include:
Beta Feedback/Bug Database—manage communication between customers and a software development team such that customer issues discovered in the beta process which are characterized as bugs are entered in a bug database (e.g., maintained by the development team).
Beta Feedback/Feature Database—manage communication between customers and a software development team such that customer issues discovered in the beta process which are characterized as features are entered in a feature database (e.g., maintained by product management).
Sales Communication/Sales Pipeline—manage communication within an organization, including channel partners.
Managing customer issues in a newly merged company—in a newly merged company, a united face is desirable on all processes, even if each company is still operating partially, substantially or entirely autonomously. Using a solution in accordance with the invention, customers could submit an issue to the merged company. Once received at the merged company, employees (e.g., key and/or identified employees) forward the issue and associated activity to required users. Once the proper system is identified, they could mark the activity appropriately, and a batch job would close down the activity and create the customer request in the appropriate back office system.
Channel Sales Issue Management—in managing a complex channel, a customer has a problem, leading the customer to submit an issue request on a predetermined website. A servlet preferably receives the issue request and, responsive thereto, creates an activity on the customer's behalf. The activity is evaluated and disposed (e.g., which channel partner should get involved and to which system the activity should be handed off). A batch job preferably pulls the information and drops it into the target system. Since multiple vendors could be involved, a solution in accordance with the present invention preferably continues to be used to facilitate communication between each organization. As individuals update the case—e.g., using internal systems—commentary objects are appended to the activity. If the internal system has an extranet portal, a URL is embedded in the message, if not a brief text description provided.

In these examples, communication and web architecture preferably are leveraged.

Keywords preferably are implemented as an organizational tool for both EM and PM and that can be used to organize hundreds of projects within an enterprise server, as well as activities within a project.

Keywords are a freeform data association tool. Keywords comprise name/value pairs. Names typically can have multiple values. The format is <keyword>=<value 1>, <value 2>. For example, if a solution in accordance with the invention is used to manage communication between beta customers and a beta program team, keywords can be created for every company in the program and for disposition of each customer issue. The keyword definition may be variously implemented. In one example implementation, a set of keywords may be:
BetaCompany=amazon.com, bn.com, siebel.com, accenture.com
IssueDisposition=SubmitToBugBase, SubmitToFeatureList
Interest Flag=marketing finance sales

Keywords may also have various types. Three example types of keywords, any one or more may be implemented:
Activity Keywords—used in a project to associate activities with keywords
Project Keywords—used to associate projects with enterprise keywords Person Keywords—used to associate people in the system with keywords

Once an activity or project is associated with a keyword, users are enabled to filter using keywords.

For either or both EM and PM, this example embodiment enables creating and publishing keyword libraries for both Activity and Project Keywords. Once published, selected users of a solution in accordance with the invention in a given Enterprise (e.g., every user in the Enterprise) will have access to the libraries.
These libraries preferably are used by Project Templates.
One concept is that of a company standard header that is included in all enterprise keyword templates. For example, this concept contemplates inclusion of “functional area” and/or “region” in project templates.
Templates can be stored as XML files in the file system.

Project Manager generally is contemplated to use folders (sometimes referred to herein as “Project Folders”) to organize activities.

In this example embodiment, either/both Keywords and Project Folders are available on an Activity screen. Someone who authors an activity could associate it with Keywords or place the activity in a Project Folder. However, it is also contemplated to control read and/or write access to either/both Keywords and/or Project Folders. For example in managing communication with customers in a beta program, it is desirable to enable hiding either/both the Project Folders and Keywords from beta customers.

This approach tends to have impact on the user interface (Ul). In one embodiment, these components would be options, such that the Ul screen layout facilitates rendering with our without these components. Examples include:
No access—the control would not be visible.
Read access—the value would be visible,
Read/write access—control would allow the user to change value.

One possible mechanism for managing access could rely on email addresses, e.g.
*@*.*—anyone involved on this project
   *@RITEPAGE.COM—anyone involved with the email domain identified, as an example, RITEPAGE
   frank@ritepage.com, jack@ritepage.com—in this case only these individuals

It is also contemplated to link to ownership—the author or the activity, project, etc.

As to reporting, existing reporting packages tend to support:
Batch reporting
Full authoring environments
An installed base of developers

Disadvantages of existing reporting packages include:
They query against a relational model instead of the object model
Lack of control and ability to tune the package to an embodiment of the instant invention
Difficulty in integrating the package into an embodiment of the instant invention.

It is contemplated that control over reports is desirable for the agenda functionality. Agendas preferably provide input to a meeting manager. In one embodiment, a meeting manager is contemplated as a tool launched in connection with a meeting (e.g., as to one or more group members, any of a physical meeting, a conference all, a web conference, a chat conference or some combination of the above), wherein one or more participants are enabled to scribe input from the meeting, wherein such participant(s) associate scribed action items arising in the meeting to particular persons (e.g., whether such persons are present in the meeting or not and whether such persons are group members at the time of the meeting), wherein such associated persons receive follow up automatically from the solution, prompting them to initiate/pursue the action items via discussions, and wherein other group members have access so as to observe progress in the person's initiating and pursuing such discussions.

In this example embodiment, various reports are contemplated. Examples of reports include:
A set of reports that are tightly integrated into the product. These reports typically support messaging, transform into agendas and can be “live”.
A set of reports written in an existing reporting package, e.g., Crystal.

Reports and agendas are contemplated to be driven by one or more factors. These factors may include, as examples, any one or more of the following:
Reports are driven from various perspectives, including as examples:
   Project/Project Folder perspective—how is a project(s) doing?
   Person perspective—how are individuals doing?
   Company/Organization—how are organizations doing?
Agendas are based on reports. It is contemplated that a reporting mechanism supports agenda functionality.
Enterprise reports are a collection of project or person reports. When a user runs an enterprise report, the enterprise part of the report determines which projects or persons to report on and then instructs each project/person to create a specific report.
Static vs. dynamic reports. Static reports are a snapshot at a point in time. Snapshots, in one contemplated embodiment, may be sent out (e.g., via email) to individuals who do not otherwise have access. Dynamic reports are rendered on the fly whenever a user requests to view the report.
Exporting to other software packages (e.g., to EXCEL via tab delimited format). It is contemplated to support EXCEL templates that graph and analyze data.

It is contemplated to provide a mechanism that enables users, in creating reports, to filter data based on criteria. The filtering criteria generally are driven by the reports provided.

Filters specify which data to include in the report. In a solution in accordance with the invention, it is contemplated to enable users to filter variously. One example embodiment enables users to filter on one or more of 3 objects:
Primitive objects and attributes. Examples include:
   Project—deadline timestamp, status, owner name, state
   Person—email
      Organizations—e.g. finance vs. sales, as well as external organizations the enterprise works with, e.g. Accenture.
   Activity—deadline timestamp, status, owner name
Project folders
Keywords—applied to Projects and Activities

Support is contemplated for relational expressions. Operators supported include =, < >,>, <, >=, <=, AND, OR. For example, support is contemplated for queries such as.
In a sales scenario, to obtain a report for large and medium size projects that have a high probability of closing this year, the expression would be: Deal Size < >“small” AND ProjectedClose< >“2003” AND Probability=“+90%”
In an agenda scenario, a query would be to obtain activities that are in a particular folder(s) and due within the next week.

It is also contemplated to enable users to create personal and/or public filters. In one example embodiment, users are enabled to create the filter, view the report, change the report template, tune the filter, save the filter and, in a follow-on step, create a “named report”. The named report would apply filter +report template to create a report.

It is also contemplated to employ the sorting and filtering mechanisms in managing lists of activities and projects, which lists preferably are handled outside the PM and EM (e.g., in a contributor tool).

In connection with reports and agendas of this example embodiment, it is contemplated to use templates. Templates describe how a selected data set is rendered. The template and template processor preferably:
Support mixing and matching data sets and templates to create different reports.
Are user editable

It is contemplated that XML, XSL template processing is employed.

Reports can be variously implemented. Two complementary forms are:
A static report, rendered as HTML, available on a website or sent in an email.
A dynamic report, available on the website. The URL would be embedded in the email.

A solution in accordance with the invention is contemplated to provide a mechanism for publishing reports. Publishing could include:
A portal—Yahoo
An intranet
Lotus Notes/Domino Server

In a solution in accordance with the invention, a report subsystem is contemplated to support both static and dynamic addressing:
Static Addressing—a list of emails, could be individuals or SMTP-based services which can publish reports on behalf of the user.
Dynamic Addressing—the list of participants is driven by the contents of the report, for example, to support:
   Include Authors
   Include Participants
   Include Follow-Up Individuals

It is also contemplated to publish to third party systems (e.g., portals, kbs, intranet sites). The Enterprise Manager preferably would be responsible for running the SMTP-based service which handles the requests and updates the target system. This form of publication may be subject to control.

It is contemplated to enable running reports at a regular interval. Once run, the report generally may be sent to all, one or more subsets (e.g., by report type) or selected group members and other recipients, whether individuals, services or other entities.

Any report created in Project Manager preferably can be accessed by Enterprise Manager. When a solution in accordance with the invention is installed and used by larger organizations, tools are contemplated for managing large numbers of projects. This management is enabled, e.g., through the keyword concept and templates.

To illustrate, if a VP of Sales were managing a worldwide sales team, the VP could potentially have a few hundred deals in the queue at any given time. Keywords and reports would be available to the VP for managing these projects. In doing so, it is contemplated that:
Each project uses keywords (e.g., the same, synonymous or translatable keywords)—so the VP could identify the projects
Each project submits data in an appropriate format (e.g., the same or translatable format)

One challenge is the distribution of information to the projects in the enterprise. Various solutions may be implemented. One solution is to create a template mechanism, e.g. one that gets organizational tools out to the team. The template mechanism may be variously implemented. For example, the template mechanism may be implemented to enable one or more of:
Agenda Templates
Report Templates
Keywords (e.g., Project, Activity etc.)
Project Folders
Project Milestones and meeting information (e.g., regular meetings are contemplated as a part of an example template. In a sales situation, weekly status reports could thus be built in.)
Project Managers (e.g., in the case set forth above, the VP could want to make sure that he or his assistant is able to co-Project Manage each project—this would give them access to the project.)

When this template mechanism is enforced, projects are created and used having identical structure.

To illustrate in the context of the above case, the VP of Sales could create a template called “Sale Initiative”. Whenever a user creates a project, a pop up menu would allow them to specify which template to use. Moreover, it is also contemplated to enable the identification of certain set(s) of users, e.g., Sales Execs, such that when a user within a particular set desires to create a project, that user directed to use only certain templates, e.g., Sales Execs create projects following the “Sale Initiative”. It is also contemplated that a user may be in various sets, enabling access to various templates based on the type of project. It is also contemplated to enable relief to users from this set-based template access (e.g., the pop up menu includes a button to enables access to the further templates as supplement to the list provided in the body of such menu and/or temporary permissions to have access to other templates).

It is contemplated to make templates Project Types, e.g. project.typename=“SalesInitiative”. This facilitates accessing the system from external systems (e.g., using Web Services).

It is also contemplated to support set(s) of company standard templates for sales, beta programs, joint development efforts, professional services, the yearly budgeting process, etc.

One example implementation would exploit XML, e.g., storing XML files on the enterprise server that can be accessed by project managers.

Turning to the Project Manager, it is contemplated that one goal of the PM organization tools is to provide a metaphor for organizing activities.

Projects may be variously organized. As examples, two ways to organize a project are:
Functional Hierarchy—a functional breakdown of the project, e.g.:
   Product Concepts
   Relational/Domain Model Design
   UI Design
   Competitive Analysis
   Early Adopters
   Business Plan
Milestones—represent high level check points in the effort. In many instances, they can have cross-functional areas.

Projects preferably are global and visible to those involved in the project, e.g., everyone or selected groups of people. Projects typically contemplate activity participation, i.e. who is involved in the project.

In contrast to a predefined organization, ad hoc organization defines project content from a less- or non-hierarchical perspective. In one implementation, this organization spans any hierarchical structure.

The Project Manager preferably also is flexible and supports the evolutionary nature of projects. In the latter, it preferably accommodates projects having various characteristics, e.g., fast or slow moving. For example, initially projects will tend to have very simple structures, with few participants and some small number of activities. As the project gains momentum—increasing in size, complexity and number of participants—the project organization tool(s) preferably scale with the project. Users preferably are enabled to add more organization as it is needed. Furthermore, any organization preferably is enabled to co-exist with all of the project information that was created before implementation of the project organizational structure.

Project organizational tools preferably also behave predictably. Their “out of the box” behaviors preferably are intuitively obvious.

It is contemplated to support joint project management. As an example, this contemplates support for different managers seeing all of the data. In this context, ownership and rights associated therewith are contemplated (e.g., one manager's right, or lack thereof, to modify/destroy organizational tools created by another manager).

A solution in accordance with the invention is contemplated to support projects having various roles. In one example, projects are a basic organizational unit in the system. In another example, projects may be stand-alone entities (e.g., not related to other projects).

For example, projects may be stand-alone entities if the solution is absent means to build and maintain the relationships. In the event projects comprise stand-alone entities, certain of the solution's features may be impacted, e.g., cross-project reporting.

If means exist to build and maintain project relationships, it is contemplated that users can use enterprise-reporting tools to query, organize and request agenda's and reports from such projects in the enterprise.

Projects preferably join a means to build and maintain the relationships, e.g., an enterprise server. This can be variously implemented. One example implementation is to use the owner's domain name included in their primary email Id. For example, if project “Get to 1.0!” has an owner with an email address of fgaldes@ritepage.com—then this project would join an enterprise server in the “RITEPAGE” domain. Of course, a challenge to joining with this approach arises if the owner were using fgaldes@galdes.com; for which “GALDES” domain exists no enterprise server. This challenge may be overcome variously, including through inclusion of a domain column in a person table, so as to lookup domains for joining.

When an enterprise server is in discover mode (finding out which projects already exist that should belong to the enterprise), the enterprise server preferably uses a set of email addresses to discover pre-existing projects. If the server's domain name is a project owner's domain name, the project is a candidate for inclusion. If not, preferably, the project remains a candidate for inclusion, but under some other handling, e.g., on a list for possible inclusion.

Projects generally are containers. As an example, projects typically contain one or more of discussions, activities, messages, schedules and other relevant information, data or content, including organizational tools—project folders, milestone folders and keywords. Generally, it is contemplated that projects can contain other projects.

A project preferably is a named container. That is, it has a title, legend, name or other denominator. Any user preferably is enabled to create a project. In doing that creation, the user typically will be asked to provide for such project selected minimum information. The minimum information for creating a project may be selected to be, e.g., a title and a due date.

In an enterprise space, projects with identical names may arise. In that light, it is contemplated to provide for unique identification of and among projects. At the data level, a unique identity may be supported using the owner id+the project name. The system preferably enforces project name uniqueness for a specific owner—e.g. Frank is precluded from having two projects named “Q1 Plans”.

A solution in accordance with the invention preferably supports flexibility in projects. As a project grows in complexity, the solution preferably has a set of tools that facilitate organization, management and communication. Furthermore, these tools typically leverage existing content in the project.

Project Folders add one or more levels of project hierarchy to a project (e.g., if folders can contain folders, plural levels are supported; at the same time, if folders do not contain folders, one level of hierarchy is supported, simplifying use).

In an example embodiment, projects may be characterized as follows:
Projects are typically created using the Project Manager application.
Once created, Project Folders are visible within the contributor application.
Project folders exist for the duration of the project—when created they preferably inherit a project due date. Once created, folders are not subject to deletion; rather, they are subject to being “deactivated”.
   a) Defining the states of a Project Folder. Various definitions may be implemented.
   b) Handling an open activity if the Project Folder is deactivated. Various solutions may be implemented. E.g., it may move to an Unfiled Project Folder OR it can remain in the deactivated folder.
Project folders typically are not nested.
When a contributor creates an activity, they typically create an activity within a project folder.
After an activity is created, the activity can be moved to a project folder by either the owner or the Project Manager.
   a) Moving an activity to a project folder preferably engenders a notification to the project manager or activity owner.
Activities typically exist only in one Project Folder. If an activity is not associated with a folder, it exists in an Unfiled Project Folder.

Project Folders generally are viewed as durable organization mechanisms that are used throughout a project's lifecycle. Typically, Project Folders are used to establish functional hierarchy for a project. For example in a sales project, the folders might include: Technical, Professional Services, Demo, and Pricing. Project managers generally are enabled to set time based organizational structures on the project using project milestones.

In an example embodiment, adding organizational structure to a project responds to the project's organic nature. A project starts, and grows. As it grows, it benefits from organization and process. Project Folders may thus be added to a project after the project starts. After the project manager adds Folders to a project, she generally sends a message out to all activity authors, asking them to categorize their activities using the new project folder structure, e.g., by a certain date. After that date, she generally would categorize all activities located in the unfilled project folder.

There are times when it may be useful to create a project folder to track a special issue. In these cases the project manager would create the project folder. Once created, the project manager could drive the issue to closure using a project milestone and making the project folder with the milestone.

It is understood from the above description that keywords are a freeform data association tool, e.g., to associate activities and/or projects.

Any project can have none, one or more keywords associated with it. Users typically are enabled to associate keywords with activities. Keywords can be used to organize data.

Keyword creation may be variously implemented. As an example, keyword creation may be reserved to the Project Manager. As another example, keyword creation may be directed for use within a specific project. Typically, creating keywords in a project is controllable (e.g., by controlling visibility of keywords).

Keywords generally support name/value pairs. In application, users may be enabled to select one value for each keyword. For example, the following keywords may be associated with an activity: amazon.com; future issue; marketing.

In an example embodiment, limitations may be placed on keywords/values. Some example limitations include: all values are unique; one keyword value per activity—e.g. in the above example, this would support associating one company value with an activity.

In Project Manager, functionality typically is provided that enables users to create reports. The reporting mechanism generally would be consistent with the Reports at the enterprise level, discussed above.

The user generally will be enabled to create reports in various ways. Two examples are:
Using the activity list—users enabled to filter and sort activities. Once they have a selection of activities of interest, they can apply the dataset to a report template.
Using the filter mechanism—users create a filter, associate with a template.

In an example embodiment, one reporting mechanism is built for both PM and EM. Some examples of parameters include:
Enable users to build reports on the fly then remember them and optionally publish them.
If an enterprise server or similar functionality is not present, enable reports to be published through other tools (e.g., static reports included in email).
Enable users to build personal catalogs of reports.

With reports, generic collection may be implemented. The collection, e.g., could be implemented so as to gather activities that are to be reported on.

Projects typically have due dates. Moreover, in an example embodiment, projects may be implemented so as to mandate having due dates.

Projects typically also have milestones. Moreover, in an example embodiment, projects may be implemented so as to mandate having milestones. In another example embodiment, projects are implemented so that, above a threshold (e.g., in number of users, activities, or other indicia of size, etc.), all projects have project milestones.

In a typical embodiment, project milestones typically focus and drive activity in the system. Milestones generally implicate milestone structure, milestone creation, milestone meetings, milestone folders and meeting agendas. Milestones may have various characteristics (e.g., typically they are inert and informational in nature). They typically are created in the Project Management. Once created, they generally are part of and appear in each participant's project schedule.

Milestones typically are implemented so as to enable a project manager to make a project milestone into a meeting (e.g., a check box). Such meetings generally have one or more of the following attributes:
Milestone Folders. When a milestone is created, the system also creates a corresponding milestone folder with the same name. For example, if a project manager creates a milestone called “Beta”, the system creates a milestone folder named “Beta”.
Agenda Template
Meeting Profile—which includes, e.g., invited attendee list (static and dynamic), initial agenda creation, update period, final agenda creation, shipping, etc.
Recurrence—daily, weekly, bi weekly, monthly, etc.
Predecessor—used to create the agenda; specifies a start point for gathering project activities. Predecessors may be, e.g., the project start date or another meeting. For example, in recurrent meetings, the preceding meeting is a logical predecessor for the current meeting.

Automatically generating the agenda can raise challenges in various circumstances. For example, where an enterprise server or similar functionality is not present, generation may be impacted. It is contemplated, in one example embodiment, that the project manager may be alone in having access to information sufficient to enable generation of an agenda in the project manager. In that case, moreover, automatic creation and distribution of an agenda is supported if the project manager's machine is up and running the solution when the report is to execute. If that is not the case, the support for the agenda would be based on a different solution.

Modes of generating reports are contemplated—at least one w/o Enterprise Server and at least one with Enterprise Server.
Without Enterprise Server—one solution has the project manager manually running the report. When they run the report they could specify live or static. With this mechanism they typically would have various options for managing the agenda creation/distribution process. Three example options include:
   Static Agenda—the project managers may be enabled to build and ship a static report to selected persons, e.g., everyone. For example, the project manager would do this before (e.g., the day before) the meeting so as to give recipients a reasonable chance to review and comment on the agenda. Any changes made to the system would not be reflected in the Static Agenda.
   Live Agenda—the project managers may be enabled to create a live agenda for the meeting. All changes to the project would preferably be reflected in the agenda at the time of the meeting. A solution in accordance with the invention would typically freeze the agenda when the meeting started (e.g., if they were using Meeting Manager).
   Live->Static Agenda—If the project manager desired to create a review cycle, and send static agendas to everyone, the manager would essentially need to create 2 agendas. They would typically create the first one before (e.g., 2 or 3 days) the meeting and ship it out; moreover, also before the meeting (e.g., the previous day or earlier in the same day), the manager would create and ship a static agenda out to the team.
With Enterprise Server—the project manager or enterprise manager typically is enabled to set up agenda parameters in advance. The enterprise server would automatically create and send out live and static agendas as specified.

Milestone folders preferably are created whenever a project manager adds a milestone to a project. A milestone folder typically inherits from the milestone it is associated with, e.g. the milestone date. Milestone folders preferably are created automatically when a project manager creates a meeting milestone.

A milestone folder preferably is manipulated through the project-meeting editor.

The UI for both of these components may be variously implemented. It is contemplated to enable access to milestone folders from other than the Project Calendar. It is also contemplated to enable a milestone/meeting list view.

Characteristics include:
Milestones may be implemented variously, including as an example so that they can only be created and manipulated in the project manager tool.
   Automatic Creation—Milestone Folders may be implemented variously, including as an example so that they are created automatically for the user whenever they create a project milestone.
End Date—Milestone Folders typically will have an end date they receive from their related milestone. For non-recurring meetings, this generally is different than the Project Due Date; for recurring milestones, it will end typically when the project ends.
   Milestone Folders typically contain activities, e.g., project and individual activities.
   Content may be variously created and associated with milestone folders, including as an example so that only the Project Manager can create and associate content with milestone folders.
   When the milestone folder hits the due date, it preferably creates a snapshot of all contained project folders and activities. This documents the state of the project for that instance in time.

When the milestone folder is created, one or more of various options may be enabled for users in associating content with the milestone folder. Some of these options include:
All—this option will associate all activities in the project with the milestone. In a small project, this can be the preferred mechanism. Specifying “all” creates dynamic agendas. As activities are added to the project, they will appear in the agenda.
Specific Project Folders—this option associates activities found in specific project folders. This option creates dynamic agendas. As activities are added to selected project folders, they are added to the agenda.
Specific Activities—this option allows users to select specific activities for the agenda. This option creates static agendas—only the selected activities are added to the agenda.

This section is to provide some insight into the use of the Milestone Folders.
Small Teams—to manage a small team, typically people will have weekly meetings with the entire team. If the team is well behaved and small (6-10 people), creating sophisticated organization structures in this environment could be a waste of time. In this scenario, the project manager may create a weekly, recurring project meeting and select the “all” option. At each meeting, the team could review all activities.
Larger Teams, smaller meetings—in larger teams, it may be beneficial to have multiple meetings with various functional areas. For example, in a development effort, it might be preferred to meet with developers in one meeting and with the marketing/sales people in another meeting. The project manager could create several project folders that support this structure.

The agenda template supports creation of either/both reports and agendas. The format may be variously implemented. Generally, it is contemplated to support default templates that are associated with projects and meetings. In one example embodiment, a template mechanism enables users to merge their own text with the agenda, as well as control the format agenda.

In another example embodiment, the system supports a standard set of Agendas and Reports. It is contemplated to make these configurable. Configuration may be variously implemented. As an example, configuration may be via a simple filtering mechanism and would support sort orders.

It is contemplated to support nested agendas. As an example, the system may be implemented to provide different versions of an agenda template. Moreover, this may be implemented with the enterprise server, which would ask each project to render itself to a specific agenda.

The meeting profile specifies details about the meeting. Default values are contemplated to be provided. Meeting profile data may include various information. As examples, such data may include one or both of:
Attendees—this can be either static or dynamic. Static attendee lists includes a list of email addresses. Dynamic attendees are based on activities which qualify for the agenda. This feature preferably supports both/either certain members (e.g., authors who create projects and/or discussions) and/or all group members. The system preferably enables the user to mix and match both static and dynamic attendee lists. For example, managers and any members are invited who have an activity that qualifies for inclusion in the agenda.
Agenda Creation—Agendas generally are created in multiple phases. For example, the Initial Agenda could be created 48 hours before the meeting and distributed to attendees. Attendees can update their activities so they accurately reflect the state of the work. Then, 24 hours before the meeting, the Final Agenda can be created and shipped to attendees. This latter agenda is reviewed in or informs the direction of the meeting.

Recurrence drives how a meeting is rescheduled. In one example embodiment, this functionality integrates to an associated calendaring mechanism, which is either part of the system or is an external package, e.g., Exchange and/or Lotus.

When a meeting is to be created, a start point informs collecting activities. In one example case, it can be the project start date. If meetings are recurrent or a meeting has a predecessor, this feature typically would enable capture of activities that were created and/or modified since the last meeting (or since some selected previous meeting).

Like the Project Manager, the Enterprise Manager may be variously implemented. In one example implementation, it is a combination of thick and thin clients. That is, the administrative tools are contemplated to be thick clients. Moreover, these tools may be derivative works of the PM client. The thin client, in turn, is contemplated to comprise a web based UI for accessing reports, agendas, checking project status, etc.

The EM is contemplated to comprise multiple components. Each component typically is implemented to have its own set of administrative tools and UIs:
Data Server—loads data into the Enterprise DB
UI—allows thin client access to thick client, application functionality. This supports users who don't have the application installed.
Report Server—serves live reports across the Enterprise.
Publication Server—runs (e.g. SMTP) services that receive the email and publishes data to other systems (As an example, this tool enables sending information to third party applications, such as Lotus Notes—e.g., if storing the data is desirable.)
Integration Server—this server exposes a pub API via SOAP. This is the server someone would use if they want to “call into” to extract data.

Project Keywords are analogous to Activity Keywords. Activity keywords describe activity attributes while project keywords describe project attributes. Project Keywords can be variously associated with projects. As examples, they can be associated either/both by the project manager using project management tools or/and by a manager using the Enterprise Management Tools.

Project keywords typically are used to describe projects from an enterprise perspective. For example, if a sales team were using a solution in accordance with the invention to manage sales activity, the sales team might have an Project Keyword Library called “Sales Keywords”. This library could contain the following Keywords and values:
DealSize=small, medium, large
ProjectedClose=Q1, Q2, Q3, Q4, 2003, 2004
Probability=Less 50%, 50%-75%, 75%-90%, +90%
DealStatus=In Progress, Closed, Hot, Cold, Dead

It is contemplated, in one example embodiment, to provide a standard set of reports with the system.

The mechanism used for creating and controlling an agenda preferably is similar to the system for agendas. Functionality for reports may be variously implemented. As an example, it may include one or more of the following:
Specifying when the report is run
Who it is sent to.
User selection of reports and being enabled to adjust report filters.

In one example embodiment, agendas engender a form of report. For example, agendas may have a different template with slightly different behavior than a report.

It is contemplated that “sending a report” may be variously implemented. If the reports are screens in the application, it is contemplated to enable users to bring reports up at anytime. However, in an embodiment where the enterprise supports thin client access, the reports may be implemented for rendering to HTML. It is also contemplated to enable users to “drill down” into a report.

Where desirable to support the handling of solution functionality from the report, reports may be implemented to embed the various information. For example, if a user wishes to send a message to one or more activities, the activity ids are embedded in the report.

In one embodiment, Meeting Manager is implemented. Preferably, it is a separate tool. This preferably works in conjunction with PM.

Integration may be variously implemented. Some points include:
Integrate to portals
Publish to portals, intranets, kb (on the net)
Custom fields—extend each table w/a Keyword. This generally is to be available in the domain model and propagated to the Public API.
Access to functionality via public soap interfaces—including reading keyword and reading/writing custom fields

This is an example embodiment of action classes to support functionality described in this document:
Create Project Folder
Deactivate Project Folder
Modifying a Project Folder
Move Activity to Project Folder
Remove Activity from Project Folder
Get Project Folders
Create a Milestone
Create a Milestone Meeting
Set Meeting Attendees
Set Meeting Recurrence
Set Meeting Predecessor
Set Meeting Agenda Template
Set Meeting Content—this manages
   All
   Add/Remove project folder
   Add/Remove activity
Review a Meeting
Create a Live Agenda
Create a Static Agenda
Send an Agenda
Create Keyword
Add Value to Keyword
Get All Keywords
Associate keyword with Activity
Get all Keywords associated with activity
Associate keyword with Project
Get all Keywords associated with project
Get activity with keywords (expression)
Get projects with keywords (expression)

Using and illustrating this example embodiment, a sales deal may evolve as follows. A small deal gets bigger as the sale exec learns more about the customer's requirements and future plans.
Phase 1—Simple Project. It starts as 3 or 4 activities in a project. The project has a name, no description, folders, etc.
Phase 2—Add Project Folders. As the deal heats up, more issues arise and more people get involved. By the end of the first week there are 18 activities and 12 people involved from 4 functional areas:
   Product Management and Development—future features, performance issues, answering explicit technical questions and real world references
   Sales—working deal issues, including RFP, product demos, etc.
   Professional Services—scoping the integration effort, resources, pulling in outside resources.
   Finance/Legal—involved in pricing and setting up a OEM deal for the customer who will become a reseller.
Phase 3—Meetings. The CEO learns of the deal and shows interest. He requests a status meeting and an RFP review meeting.
   Status Meeting Milestone. Check “Meeting” and “Create Agenda”. Move all project folders into Status Meeting Milestone Folder. 48 hours before the meeting agenda will be sent. Agenda will be based on a template. 12 hours before the meeting—a static copy will be created and sent to all participants.
   Final Review—to review final sales pitch and RFP. Set up as meeting, request agenda and specify “Status Meeting” as predecessor. Only Activities that are open or changed status since last meeting are included in Agenda. Sent out 48 hours in advance, Static Copy 12 hours before meeting.

Using and illustrating this example embodiment, a beta program may evolve as follows. A high tech company is about to rollout a beta release of their flagship product. The company has not had success with the intranet/beta site in the past. The customers did not always use it; they used emails instead.
The company asks its customers to use a solution in accordance with the invention in submitting issues and other feedback
Project Folders—are used to organize activities based on product functional area
Keywords—are set up to organize customer activities across organizational hierarchy. They use the Group/Keyword feature which allows users to create groups of keywords. For example, they create the following Groups/Keywords
   Company—<name of each company in the beta test>
   Dispositioning—bug, feature, dismissed
   InterestFlag—marketing, finance, sales
The keywords classification are only visible to employees, customers can't see them.
Project Milestones—set up as weekly recurrent meetings. All Project Folders are added to the list. The agenda is created and sent automatically. The agenda and meeting minutes are controlled documents and not visible to everyone. In such cases, the beta customers typically have the role of Authors and, in that regard, they are not given visibility into agenda and dispositioning.
Meetings—during the meeting, specific keywords are updated—for example, issues to be submitted to the bug base are set to “bug”, while issues which are potential features are set to “feature”
A developer writes a simple script which walks the database, looking for Activities in this project which have:
   activity.status=“Open”
   activity.keyword=“bug”
These activities are moved to the bugbase (copy activity.Description, all commentary objects), set activity.status=closed, append a canned message stating the activity has been moved to the bugbase. If the bugbase is web enabled, should be able to embed the URL to the bugbase and bug that was just created.
The same functionality would be created for pulling items destined for the Issue Database, as well as sending messages to people based on the value of InterestFlag.

Using and illustrating this example embodiment, management of a national sales team may evolve as follows. The team is scattered across the U.S.
Each regional manager acts as a project manager for all of the deals which are reviewed at the weekly Sales Pipeline Meeting.
The regional manager creates a set of template files that is automatically shared with each project that is created. This template includes:
   Regular meetings and the agenda specification
   Standard Project Keywords (see below)
Each potential deal is a project
Project structure is loose and ad hoc. Sales executives add structure as it is needed, typically via template files. In most deals, it is typical that 3 or 4 project folders are added.
Each national manager creates Keywords and puts them in a template file—all projects automatically “inherit” these keywords in the template. These keywords are associated with the projects (not specific activities). The template contains the following keywords:
   Deal Size=small
   Deal Size=medium
   Deal Size=large
   Projected Close=1 Q2002
   Projected Close=2Q2002
   Projected Close=3Q2002
   Projected Close=4Q2002
   Projected Close=2003
   Probability=Less 50%
   Probability=50%<75%
   Probability=75%-90%
   Probability=>90%
   Deal Status=In Progress
   Deal Status=Closed
   Deal Status=Hot
   Deal Status=Cold
   Deal Status=Dead
At each meeting, the status of each deal is reviewed—including all open activities. At the end of each review, the Project Keywords are updated to reflect the current state of business.

The national manager uses the enterprise edition to create weekly meetings. The agenda template selects all projects with Deal Size=large. At the end of the quarter, the manager might target business that is HOT, BIG, +90%, Projected Close=?Q2002 (where ? denotes the current quarter)

Although the invention has been disclosed with reference to several embodiments, it is to be understood that, from reading this description, those of skill in the art may appreciate changes and modification that may be made which do not depart from the scope and spirit of the invention as described above and claimed hereafter. Thus, the invention is not limited to the embodiments described, but is intended to encompass any such modifications with the scope of the claims hereafter.

1. A method for handling messages among group members of a work group, the method comprising:
receiving a message from a first group member;
associating the message received from the first group member with a container;
making the container available to selected group members so as to make the message from the first group member available to such selected group members;
receiving a message from a second group member;
associating the message received from the second group member with the container;
making the container available to such selected group members so as to make the message from the first group member available to such group members, together with the message from the first group member.
